(19) United States
(12) Patent Application Publication
(10) Pub. No.: US 2001/0056455 A1
(43) Pub. Date: Dec. 27, 2001

(54) Family of low power, regularly structured multipliers and matrix multipliers

(76) Inventor: Rong Lin, Geneseo, NY (US)

Correspondence Address: Thomas R. FitzGerald, Esq., Jaeckle Fleischmann & Mugel, LLP, 39 State Street, Rochester, NY, 14614-1310, US

(21) Appl. No.: 09/812,030

(22) Filed: Mar. 19, 2001

Related U.S. Application Data
(60) Provisional application No. 60/190,438, filed on Mar. 17, 2000.

(51) Int. Cl. G06F 7/50

(52) U.S. Cl. 708/700

(57) ABSTRACT

A family of embodiments of a new class of CMOS VLSI computer multiplier circuits that are simpler to fabricate, smaller, faster, more efficient in their use of power, and easier to scale in size than the prior art. The normal binary adder circuit unit is replaced by the innovative shift switch circuit unit. Use of the shift switch circuit sharply reduces fluctuations of power caused by plurality variations in the bit representations of the input, intermediate and output numbers. Reduced-scale devices are used in shift-switch pass-transistor signal restoration circuits, significantly reducing the size, power demand, and power dissipation of internal circuitry, in contrast to ordinary multiplier design. The simplicity of the circuit design allows multiplier partial-product reduction in fewer logic stages than existing comparable designs allow, showing speed improvement over such designs. The circuit design simplicity and the use of reduced-scale devices require less VLSI area than existing designs need, facilitating integration in VLSI microprocessors. Modular circuit organization simplifies scaling for larger operands without the circuit complications of existing designs. The design includes a critical flip of the physical layout of the partial-product matrix at each size level, simplifying the layout of traces in the circuit at all size scales. Finally, the application of reconfigurable design principles to the easily-scaled layout reduces significantly the mean demand for computing resources over a wide range of multiplication bit-width scales, as compared to existing designs. Overall, the orchestrated integration of these diverse design innovations makes possible the implementation of simpler, faster, smaller, more efficient, more flexible, and easier-to-build VLSI multiplication circuits than the current art reveals.

### This patent claims the benefit of the priority date of U.S. Pat. No. 6,125,379 filed Feb. 11, 1998 and Ser. No. 60/190,438 filed Mar. 17, 2000 and Ser. No. 09/415,380 filed Feb. 21, 2000.

### FIELD OF INVENTION

The present invention relates generally to very-large-scale integrated (VLSI) circuits, and more specifically to low-power, high-performance VLSI multiplier circuits.

### DEFINITIONS

The term “p-type 4-bit state signal” here refers to a column of four bits, where only one bit is 1 and the other three bits are all 0. The value of the state signal is I (0≦I≦3) if the 1 bit is in position I.

The term “n-type 4-bit state signal” here refers to an signal with an opposite representation to a p-type state signal, i.e. the unique bit is 0, instead of 1.

The term “binary-to-state signal converter” here refers to a circuit which produces a shift switch signal representing a count of the number of independent input signal lines in an “on” state. Each distinct shift switch signal is used to represent a distinct binary signal.

The term “bit-weight position” here refers to a column of the partial product matrix, in which each bit is in the same binary position with respect to the final product. A higher bit-weight position refers to a column in a binary position with higher significance, e.g., in the 2⁴ place compared to the 2³ place; a lower bit-weight position refers to a column in a binary position with lower significance.

The term “Booth recoding” here refers to a well-known scheme for substantially halving the number of bits in a given bit-weight position by encoding the numbers being accumulated in that position.

The term “compressor” here refers to a circuit which produces a shift switch signal output resulting from combining an input shift switch signal with one or more independent input bit signals.

The term “counter” here refers to a circuit which produces a binary output value by counting the number of input signal lines in an “on” state.

The term “virtual multiplier” here refers to a multiplier without the results of the final stage partial product reduction being added.

The term “virtual product” here refers to the results of the final stage partial product reduction of the virtual multiplier.

In drawings and text, signal lines are frequently labeled and referred to with lowercase letters or lowercase letters followed by a numeric digit, e.g., “b” or “x0”. The signal values present on an interrelated set of these lines are referred to either with a capital letter or the line labels in parentheses. A hypothetical example of such overall usage would be “signal R, or (r0 r1 r2 r3), is present on lines r0, r1, r2, and r3.”

Another usage denotes inverse signals: the presence of a macron over a signal letter. Thus the labels c and c with an over bar (macron) refer respectively to a signal and its inverse, as used in dual-rail circuit connections.

The use here of the notation (m, n), where m and n are whole numbers, defines a circuit with m input bits and n output bits. The notation is used primarily herein for counters, adders, compressors, or some modification of any of these, but it may refer to any other type of circuit.

Discussion of Prior Art

Of the basic arithmetic operations performed in computers, multiplication and division require the most time and the most hardware resources to carry out. In contrast to addition, multiplication requires that each binary digit of one input operand be multiplied by each binary digit of the other input operand, producing what is called a partial product matrix. To complete the multiplication, the partial product matrix must then be summed. Faster and less-resource-intensive summing of the partial product matrix has been the subject of much research.

The current prevalent strategy in the art is to use ordinary counter logic to achieve acceptable multiplier design goals. This requires balancing among the multiplier's power, complexity, size and speed criteria by decomposing the monolithic large-number multiplication process into separate parallel and serial steps. The steps translate into interconnected circuits each of which carries out a part of the process. Even with this strategy, the current use of counter logic places lower bounds on power dissipation, circuit footprint, fabrication cost, and time required to complete a multiplication, and places upper bounds on the size of numbers that can be multiplied using a given design. These bounds vary from design to design, but generally prevent significant advantages from accruing to any one acceptable design.

Certain design approaches form the basis for most current designs of multipliers. The fundamental work of Dadda in digital multiplier design, Booth in the design of recoders to improve the speed and simplicity of signed binary multiplication, and Wallace in design of trees to improve speed, together constitute the largest individual advances in the field. Hennessy and Patterson sum up many of the salient issues and innovations in their book Computer Architecture—A Quantitative Approach, Second Edition, Morgan Kaufmann, 1996, in Appendix A, Computer Arithmetic. Yu et al., in U.S. Pat. No. 5,790,446, apply matching-delay techniques and reduced interconnect lengths on a Booth-encoded or radix-4-encoded multiplier to improve speed and area usage, but such changes do not address issues of scalability, cost, power consumption and regularity.

Palaniswami, in U.S. Pat. No. 5,260,889, teaches a method and apparatus for performing rounding calculations in parallel with multiplications, but this addresses only the speedup of the multiplication.

To multiply two numbers requires each digit of the first number to be multiplied by each digit of the second. In effect this creates a matrix of digit-by-digit products which must be summed to arrive at a final product. This matrix is called a partial product matrix, and is a special form of array in which all digits of the final product must be summed and combined in order with the other digits to yield the final product. The summing of the partial product matrix is along its principal diagonals (see FIG. 16b). It is the exact binary equivalent of the familiar process of hand multiplication of two multiple-digit numbers, where the partial product matrix is skewed. Here is a decimal illustration:

$$\begin{matrix}327 \\ 848 \\ 2616\end{matrix}$$

$$\begin{matrix}1308 \\ 2616 \\ 277296\end{matrix}$$

In this illustration, the partial product matrix comprises the three rows just above the bottom line. With the skewed structure of the matrix for traditional multiplication as shown, the principal diagonal of the partial product matrix here appears as the vertical column showing the numbers 6, 0, and 6. Due to carries and the number of values to be added, the column to its left, here showing 2, 3, and 1, must be capable of containing the largest possible column sum value, for any size matrix. The height of this column, and the number of columns to be combined, determine the size and processing time of the multiplication. The taller the highest column, the more additions must be performed serially, and the more time the multiplication will take. This is one of the key problems to be solved in computer multiplication.

In general, the traditional approaches to parallel multiplication have three major drawbacks in the design of high performance larger size (say 64×64-bit) multipliers: first, design irregularity is inherent in the bit reduction of a large partial product matrix (even using Booth recoding) into two numbers; second, significant load/wire imbalance arises due to the differing column heights of the large partial product network; third, these multipliers exhibit a large power dissipation due to the use of large number of high-speed, small-size binary logic parallel counters such as (3, 2) and (4, 2). An approach using non-full-swing full-swing pass-transistor logic circuits works only for small-size multipliers (16×16 as reported), since packed pass-path cross stages are required in order to reduce the size of its (4, 2) parallel counters. For larger multipliers, this approach is not effective.

In the realm of mathematics, matrix multiplication is an important and frequently-used special purpose arithmetic operation, widely used for solving large numerical problems. In a typical non-reconfigurable high-precision computer-arithmetic system, multiplying two 4×4 matrices of 16-bit items requires 26 multiplications, multiplying two 8×8 matrices of 8-bit items requires 2⁹ multiplications, and multiplying two 16×16 matrices of 8-bit items requires 2¹² multiplications. Using software on a core central processor to perform matrix multiplication computation is wasteful of both time and hardware resources.

Hardware implementation of an expanded multiplier in a computer-arithmetic system improves multiplication performance in terms of speed, but inevitably faces limitations on the amount of VLSI area available. Excessive VLSI area usage impacts both cost and performance. Restricting VLSI area in the design of such a processor introduces a conflict between its versatility and computation speed. If the processor is designed to compute the product of two input matrices with item precision ranging from 8-bit (integer) to 64-bit (high precision), the multipliers used in the processor should be large in size (64×64 bits). Coupled with VLSI area restrictions, such a large multiplier circuit curtails the number of items which can be concurrently stored and processed in the matrices. Consequently, multiplication of input matrices with a large number of lower precision items results in waste of the 64-bit hardware. But if the hardware is designed to handle the low-precision cases by reducing the size of the multipliers to 8×8 bits or 16×16 bits, matrix multiplication for input arrays with higher precision items become impossible without the use of slow software methods.

Several dedicated architectures for matrix multiplication, mainly in systolic array forms, appear in the literature. All of the known architectures have two general drawbacks: First, they provide no solution to the above design conflict problems; all multipliers used in those systems have a fixed size. This makes them inefficient in handling inputs with a precision lower than the fixed size, and incapable of processing inputs with higher precision. Second, they display large power dissipation, which is a major concern in VLSI design.

### PARTIAL LIST OF REFERENCE NUMBERS

Following is a list of the most significant reference numbers used in the text and drawings. This list is provided to assist in connecting references to the components of the present invention. Some reference numbers may have multiple entries, showing their appearance in an important role in more than one figure.

102 (FIG. 12.) The input converter circuit for the shift switch (6, 2) parallel counter.

104 (FIG. 15.) The q-circuit for the shift switch (6, 2) parallel counter, showing the connections with the restoration circuit and the encoder.

106 (FIG. 14.) The p-type restore circuit and the output encoder circuit for the shift switch parallel counter.

107 (FIG. 14.) The encoder for the shift switch (6, 2) parallel counter.

112 (FIG. 13a.) The shift bar circuit: state signal addition of one bit in a 4-bit shift bar circuit.

114 (FIG. 14.) The restoration circuit for the shift switch (6, 2) parallel counter.

202 (FIG. 9b.) The shift switch (2, 2) counter

203 (FIG. 9.) The shift switch (3, 2) tiny adder with differential signal swing restoration.

203d (FIG. 9a.) The shift switch (3, 2) counter with differential signal swing restoration and dual outputs.

204 (FIG. 10.) The shift switch tiny (4, 2) counter with differential signal swing restoration.

205 (FIG. 24.) The shift switch (5, 2) counter.

206 (FIG. 1.) A shift switch (6, 2) parallel counter with 4-bit state signals X=(x0 x1 x2 x3),M and R.

206 (FIG. 1a.) The block structure of the shift switch (6, 2) parallel counter.

206a (FIG. 23.) The shift switch (6, 2) a counter.

207 (FIG. 2.) The shift switch (7, 2) parallel counter.

208 (FIG. 3.) The shift switch (8, 2) parallel counter 208 (FIG. 3a.) The block structure of the shift switch (8, 2) parallel counter

209 (FIG. 4.) The shift switch (9, 2) parallel counter.

209 (FIG. 4a.) The block structure of the shift switch (9, 2) parallel counter

310 (FIG. 8.) The non-Booth-recoding-based, three-stage partial product reduction network.

320 (FIG. 7.) The floating point, non-Booth-recoding-based, three-stage partial product reduction network.

330 (FIG. 6.) The non-floating point, Booth-recoding-based, two-stage partial product reduction network.

340 (FIG. 5.) The floating point, Booth-recoding-based, two-stage partial product reduction network.

505 (FIG. 16a.) The partial product matrix generated by two 4-bit numbers X and Y.

510 (FIG. 16b.) The partial product matrix, added along the diagonal lines.

520 (FIG. 16c.) Multiplication of two 8-bit numbers using four 4×4 multipliers, showing the distribution of input bits to the component multipliers.

520 (FIG. 16d.) Multiplication of two 8-bit numbers using four 4×4 multipliers, showing the addition of product bits from the component multipliers.

520 (FIG. 17.) The 8×8-bit (virtual) multiplier. The core of the circuit shows an array of (6, 2) counters.

530 (FIG. 20.) The 16×16 virtual multipliers and the corresponding (5, 2) based shift switch counter arrays. 532 (FIG. 20a.) The shift switch parallel counter array for the 16×16 virtual multiplier.

540 (FIG. 21.) The 32×32 virtual multipliers and the corresponding (5, 2) based shift switch counter arrays.

550 (FIG. 22.) The 64×64 virtual multiplier and the corresponding (5, 2) based shift switch counter.

550 (FIG. 25.) The complete block form of the 64×64 multiplier, showing all levels of nesting of the component virtual multipliers.

805 (FIG. 27.) The reconfigurable processor, showing multiplication of two 8-bit numbers, i.e. h=1, b=8, m=4.

806 (FIG. 28.) The reconfigurable processor, showing pipelined multiplication of two matrices, X2×2 and Y2×2, of 4-bit elements, producing Z2×2 (5-bit items), here h=2, b=4, m=4.

810 (FIG. 29.) Reconfigurable matrix multiplier of s=8, m=4, using (s/m)2=4 4×4 multipliers, showing the circuitry needed to perform both the multiplication of two 8-bit numbers and the pipelined multiplication of two 2×2 matrices of 4-bit elements.

810 (FIG. 29b.) Diagram symbol for the reconfigurable matrix multiplier of s=8, m=4 (Block-1) in FIG. 29.

811, 812 (FIG. 29a.) State switches for the reconfigurable matrix multiplier in FIG. 29, showing the states of switch-a and switch-b in FIG. 29.

820 (FIG. 30.) Reconfigurable matrix multiplier of s=16, m=4, i.e. with size 16 and using (s/m)2=16 4×4 multipliers.

820 (FIG. 30a.) Diagram symbol for the reconfigurable matrix multiplier of s=16, m=4 (Block-2) in FIG. 30.

826 (FIG. 30b.) 3-n 16-b adder for the reconfigurable matrix multiplier in FIG. 30.

829 (FIG. 30c.) Block 1 and accumulators for reconfigurable matrix multiplier in FIG. 30.

830 (FIG. 31.) Reconfigurable matrix multiplier of s=32, m=4, using (s/m)2=64 4×4 multipliers.

830 (FIG. 31a.) Diagram symbol for the reconfigurable matrix multiplier of s=32, m=4 (Block-3) in FIG. 30a.

840 (FIG. 32.) Reconfigurable matrix multiplier of s=64, m=4, using (s/m)2=256 4×4 multipliers.

860 (FIG. 33a.) Detail of matrix multiplier of s=16, m=4, showing the input duplication network.

869 (FIG. 33b.) Switch detail of matrix multiplier of s=16, m=4, showing the switch states for input options.

870 (FIG. 33c.) Detail of matrix multiplier of s=16, m=4, showing the input permutation (distribution) network.

### SUMMARY

The present invention comprises a family of embodiments of a new class of CMOS VLSI computer multiplier circuits that are simpler to fabricate, smaller, faster, more efficient and logical in their use of power, and easier to scale in size than the prior art. As its foundation building block, the invention replaces the normal binary adder circuit unit with the innovative shift switch circuit unit. The invention's multiple implementations of its different shift switch circuits sharply reduce fluctuations of power caused by plurality variations in the bit representations, referred to as p-type 4-bit state signals. A 4-bit state signal based parallel counter circuit can reduce its transistor's logic transitions significantly during an operation because no more than half (or 2 out of 4) of the signal bits are subject to value-change at any logic stage. Furthermore, three out of four p-type state signal bit-paths propagate 0 bits, while only one path propagates 1 or level-high signal bit. The invention reduces leakage current that occurs only in the area occupied by level-high signal bits. In its worst case, with the invention, approximately a quarter of the total signal passing area of a parallel counter circuit is with level 1 signal bits compared to about a half of the signal passing area for a binary logic circuit. This unique circuit feature leads to a significantly smaller leakage power dissipation, compared to other CMOS style circuits.

The invention uses reduced-scale devices in its shift-switch pass-transistor signal restoration circuits. This size reduction significantly reduces the size, power demand, and power dissipation of its internal circuitry, in contrast to ordinary multiplier design. The simplicity of the invention's circuit design allows multiplier partial-product reduction in fewer logic stages than existing comparable designs allow, making it faster than such designs. The invention's simplicity and its use of reduced-scale devices require less VLSI area than existing designs need, making the invention more attractive for integration in VLSI microprocessors than are existing comparable designs. The invention's modular circuit organization simplifies the scaling of the design to larger operands without the circuit complications of the prior art. The invention's layout design flips the physical layout of the partial-product matrix at each size level, simplifying the layout of traces in the circuit as it scales up in size. Finally, the invention applies reconfigurable-mesh design principles to its own easily-scaled layout, reducing significantly the mean demand for computing resources over a wide range of multiplication bit-width scales, as compared to existing designs. Overall, by its orchestrated integration of these diverse design innovations, the invention makes possible the implementation of simpler, faster, smaller, more efficient, lower-powered, more flexible, and easier-to-build VLSI multiplication circuits than the current art reveals.

### DESCRIPTION OF DRAWINGS

FIG. 1. A shift switch (6, 2) parallel counter with 4-bit state signals X=(x0 x1 x2 x3), M and R.

FIG. 1a. The block structure of the shift switch (6, 2) parallel counter.

FIG. 1b. The connection of the shift switch (6, 2) parallel counters 206 in contiguous columns of different weights.

FIG. 2. The shift switch (7, 2) parallel counter.

FIG. 3. The shift switch (8, 2) parallel counter.

FIG. 3a. The block structure of the shift switch (8, 2) parallel counter.

FIG. 4. The shift switch (9, 2) parallel counter.

FIG. 4a. The block structure of the shift switch (9, 2) parallel counter.

FIG. 5. The floating point, Booth-recoding-based, two-stage partial product reduction network, reducing a 28b-height matrix to 2 numbers, using shift switch (6, 2) and (8, 2) parallel counters.

FIG. 6. The non-floating point, Booth-recoding-based, two-stage partial product reduction network, reducing a 33b-height matrix to 2 numbers, using shift switch (8, 2) and (9, 2) parallel counters.

FIG. 7. The floating point, non-Booth-recoding-based, three-stage partial product reduction network, reducing a 53b-height matrix to 2 numbers, using shift switch (7, 2), (6, 2) and (4, 2) parallel counters.

FIG. 8. The non-Booth-recoding-based, three-stage partial product reduction network, reducing a 64b-height matrix to 2 numbers, using shift switch (9, 2), (6, 2 and (4, 2) parallel counters.

FIG. 9. The shift switch (3, 2) tiny adder with differential signal swing restoration.

FIG. 9a. The shift switch (3, 2) counter with differential signal swing restoration and dual outputs (adder designated (3, 2)d, “d” for “dual”).

FIG. 9b. The shift switch (2, 2) counter.

FIG. 10. The shift switch tiny (4, 2) counter with differential signal swing restoration.

FIG. 11. The 4-bit state signals and their meanings.

FIG. 12. The input converter circuit for the shift switch (6, 2) parallel counter.

FIG. 13a. The shift bar circuit: state signal addition of one bit in a 4-bit shift bar circuit.

FIG. 13b. The shift bar circuit: state signal addition of two bits in a 4-bit shift bar circuit.

FIG. 13c. The shift bar circuit: state signal addition of one bit in a 4-bit shift bar circuit, with the bit value equal to 2.

FIG. 13d. The shift bar circuit: state signal addition of one bit in a 2-bit shift bar circuit.

FIG. 14. The p-type restore circuit and the output encoder circuit for the shift switch parallel counter.

FIG. 15. The q-circuit for the shift switch (6, 2) parallel counter, showing the connections with the restoration circuit and the encoder.

FIG. 16a. The partial product matrix generated by two 4-bit numbers X and Y.

FIG. 16b. The partial product matrix, added along the diagonal lines (note: each product bit is designated by a small circle and the carry bit by a marked circle.

FIG. 16c. Multiplication of two 8-bit numbers using four 4×4 multipliers, showing the distribution of input bits to the component multipliers.

FIG. 16d. Multiplication of two 8-bit numbers using four 4×4 multipliers, showing the addition of product bits from the component multipliers.

FIG. 17. The 8×8-bit (virtual) multiplier. The core of the circuit shows an array of (6, 2) counters. Note: here (6, 2) is the shift switch parallel counter, (3, 2) and (2, 2) are shift switches (with 2-bit state signals). The (6, 2)a counter is made up of three (3, 2) counters and a (2, 2) counter. The formula for the (6,2)a counter: i0+i1+i2+i3+i4+i5+2*Cin0+2*Cin1=2*S+4*C+4*Cout1+Cout0.

FIG. 18a. Recursive matrix decomposition, without the invention's repositioning (prior art).

FIG. 18b. Recursive matrix decomposition, with the invention's repositioning in square order.

FIG. 18c. Recursive matrix decomposition, with the invention's repositioning in square order, showing the next higher level of nesting of the circuits.

FIG. 19a. The full 4-branch-tree distribution of the 16-bit inputs X and Y (bold) for a 16×16 matrix A′, into four 8×8 multipliers.

FIG. 19b. The full 4-branch-tree distribution of the 32-bit inputs X and Y (bold) for a 32×32 matrix A″, into four 16×16 multipliers.

FIG. 19c. The full 4-branch-tree distribution of the 64-bit inputs X and Y (bold) for a 64×64 matrix A′″, into four 32×32 multipliers.

FIG. 20. The 16×16 virtual multipliers and the corresponding (5, 2) based shift switch counter arrays (at bottom).

FIG. 21. The 32×32 virtual multipliers and the corresponding (5, 2) based shift switch counter arrays (at bottom).

FIG. 22. The 64×64 virtual multiplier and the corresponding (5, 2) based shift switch counter arrays (at bottom).

FIG. 23. The shift switch (6, 2)a counter: i0+i1+i2+i3+i4+i5+2Cin0+2Cin1=Cout0+4Cout1+2s+4c.

FIG. 24. The shift switch (5, 2) counter.

FIG. 25. The complete block form of the 64×64 multiplier, showing all levels of nesting of the component virtual multipliers.

FIG. 26a. The bit reduction case for the (5, 2) based shift switch counter arrays: A column with 7 input bits connecting with the lower and higher neighbor columns, each with 5 input bits.

FIG. 26b. The bit reduction case for the (5, 2) based shift switch counter arrays: A column with 6 input bits connecting with the lower and higher neighbor columns, each with 5 input bits.

FIG. 26c. The bit reduction case for the (5, 2) based shift switch counter arrays: A column with 6 input bits connecting with the lower and higher neighbor columns, each with 4 input bits.

FIG. 27. The reconfigurable processor, showing multiplication of two 8-bit numbers, i.e. h=1, b=8, m=4. Note: “3-n 8-b adder” is an adder adding 3 8-bit numbers.

FIG. 28. The reconfigurable processor, showing pipelined multiplication of two matrices, X_{2×2} and Y_{2×2}, of 4-bit elements, producing Z_{2×2} (5-bit items), here h=2, b=4, m=4.

FIG. 29. Reconfigurable matrix multiplier of s=8, m=4, using (s/m)²=4 4×4 multipliers, showing the circuitry needed to perform both the multiplication of two 8-bit numbers and the pipelined multiplication of two 2×2 matrices of 4-bit elements. Note: block-1 (see symbol) is for the reconfigurable processor excluding the accumulators.

FIG. 29a. State switches for the reconfigurable matrix multiplier in FIG. 29, showing the states of switch-a and switch-b in FIG. 29.

FIG. 29b. Diagram symbol for the reconfigurable matrix multiplier of s=8, m=4 (Block-1) in FIG. 29.

FIG. 30. Reconfigurable matrix multiplier of s 16, m=4, i.e. with size 16 and using (s/m)²16 4×4 multipliers.

FIG. 30a. Diagram symbol for the reconfigurable matrix multiplier of s=16, m=4 (Block-2) in FIG. 30.

FIG. 30b. 3-n 16-b adder for the reconfigurable matrix multiplier in FIG. 30.

FIG. 30c. Block 1 and accumulators for reconfigurable matrix multiplier in FIG. 30.

FIG. 31. Reconfigurable matrix multiplier of s=32, m=4, using (s/m)²=64 4×4 multipliers.

FIG. 31a. Diagram symbol for the reconfigurable matrix multiplier of s=32, m=4 (Block-3) in FIG. 30a.

FIG. 32. Reconfigurable matrix multiplier of s=64, m=4, using (s/m)²=256 4×4 multipliers.

FIG. 33a. Input networks for matrix multiplier of s=16, m=4, showing the input duplications networks.

FIG. 33b. Detail of matrix multiplier of s=16, m=4, showing the switch states for input options: state 1, 2, or 3 receiving data from level-1, level-2, or level-3 ports respectively.

FIG. 33c. Detail of matrix multiplier of s=16, m=4, showing the input permutation (distribution) networks.

FIG. 34. The matrix multiplier of s=16, m=4, showing the overall processor architecture.

FIG. 35a. Input networks for matrix multiplier of s=16, m=4 in operation, showing the example, and the input streams with switch state 1 (for input option 1). The bold line indicates that data are pipelined to 4×4 multiplier B2, and the products X₁₁Y₁₄, X₁₂Y₂₄, X₁₃Y₃₄, and X₁₄Y₄₄ will be accumulated to a product-matrix element Z₁₄.

FIG. 35b. Input networks for matrix multiplier of s=16, m=4 in operation, showing the example of input streams with switch state 2. The bold line indicates that data are pipelined to 4×4 multiplier A2, B2, C2, D2 and the products X₁₁ Y₁₂ and X₁₂Y₂₂ will be accumulated to a product-matrix element Z₁₂.

FIG. 36a. Partitioning input matrices X and Y of b-bit items, showing the multiplication of partition sub-matrices for the X_{1×2}×Y_{2×1} case.

FIG. 36b. Partitioning input matrices X and Y of b-bit items, showing the multiplication of partition sub-matrices for the X_{2×1}×Y_{1×2} case.

FIG. 36c. Partitioning input matrices X and Y of b-bit items, showing the multiplication of partition sub-matrices for the X_{2×2}×Y_{2×1} case.

### DETAILED DESCRIPTION OF INVENTION

The present invention comprises numerous multiplier embodiments constructed using three essential major features: a partial product matrix reduction circuit using (6, 2) based parallel counters, a regularly-structured multiplier, and a reconfigurable multiplier. All three features derive unique value from the innovative shift switch circuits and methods which are the subject of U.S. Pat. No. 6,125,379, incorporated herein by reference.

The first major feature of the present invention is the shift-switch-based partial product matrix reduction circuit, which supports rapid and compact multiplication of two 64-bit numbers or two 64-bit floating point numbers with 53-bit mantissas. The second feature of the invention incorporates the first feature in a regularly structured design which applies a novel square recursive decomposition to the partial product matrix to produce a fast, simply-interconnected, and trace-optimized multiplier architecture. The third feature of the invention applies the first and second features in a reconfigurable multiplier capable of computing the product of mathematical matrices of varying degree with simple reconfiguration controls. Taken together, these three features provide sharply-improved use of multiplier resources and sharply-reduced fluctuation in power demand, thus enabling a wide range of embodiments of the invention.

The Matrix Reduction Circuit

The first major feature of the invention, its family of matrix reduction circuits, accelerates the process of multiplication of two numbers by incorporating circuit design improvements which simplify and optimize the processing required to calculate the partial product matrix.

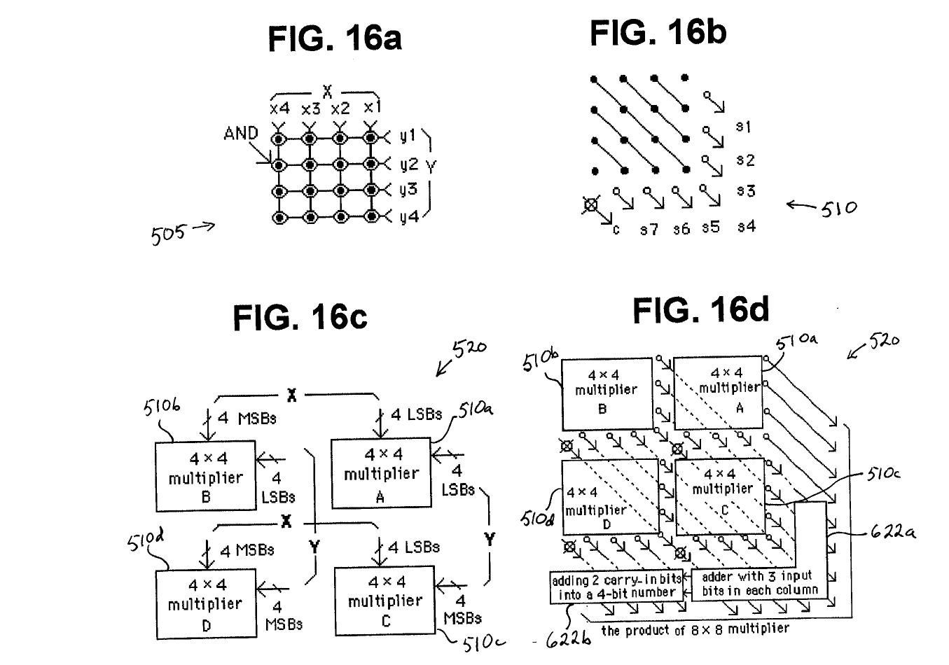

The partial product matrix is shown in a 4-bit by 4-bit form in FIG. 16a and FIG. 16b. In FIG. 16a a pair of 4-bit input numbers, X (x1 x2 x3 x4) and Y (y1 y2 y3 y4) appear as the column and row entries respectively of the matrix. At each matrix intersection, a unique pair of binary digits is multiplied to produce a partial product bit. In FIG. 16b, the direction of summation of partial product bits is shown by the diagonals through the matrix, and the resulting partial product sums (including the carrys of each column) for all columns (bit-weight positions) are shown as s1, s2, . . . s7 with the final carry bit positioned following s7. The number formed by bits of s1, s2, . . . , s7, and c is the complete product of the multiplication.

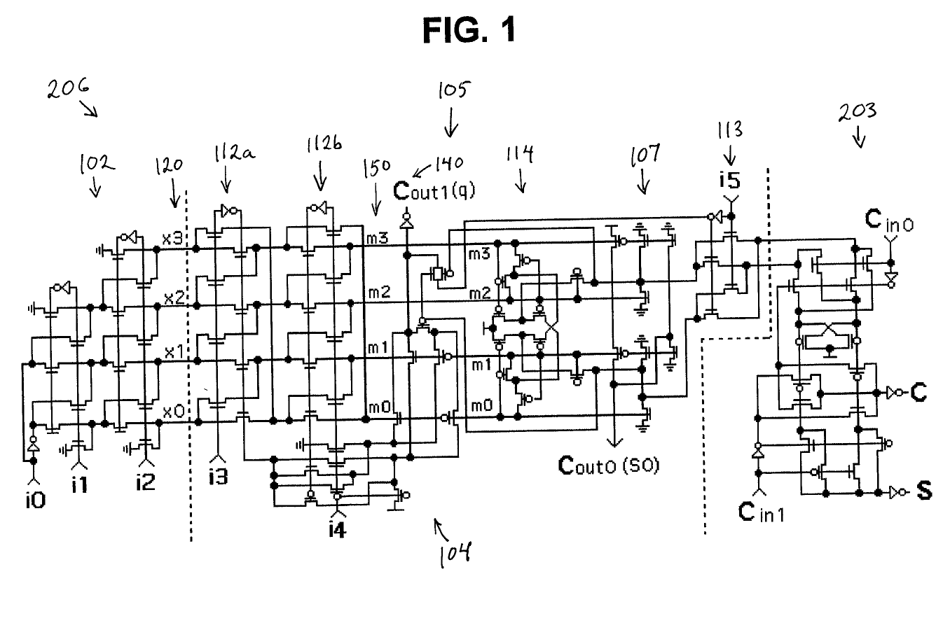

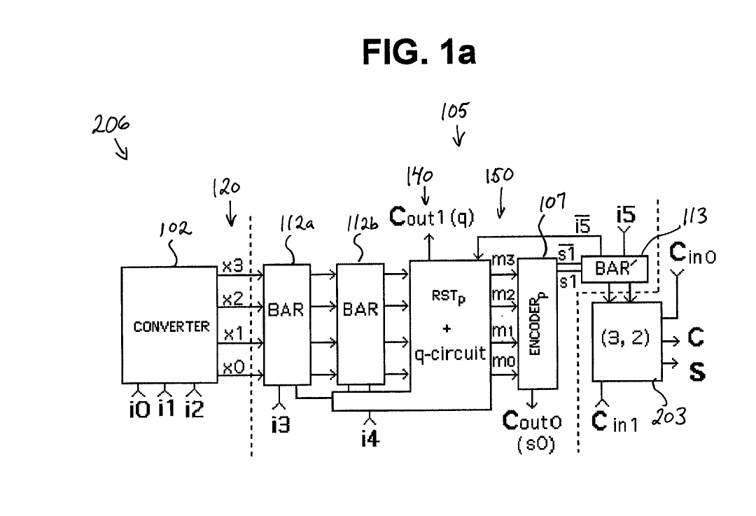

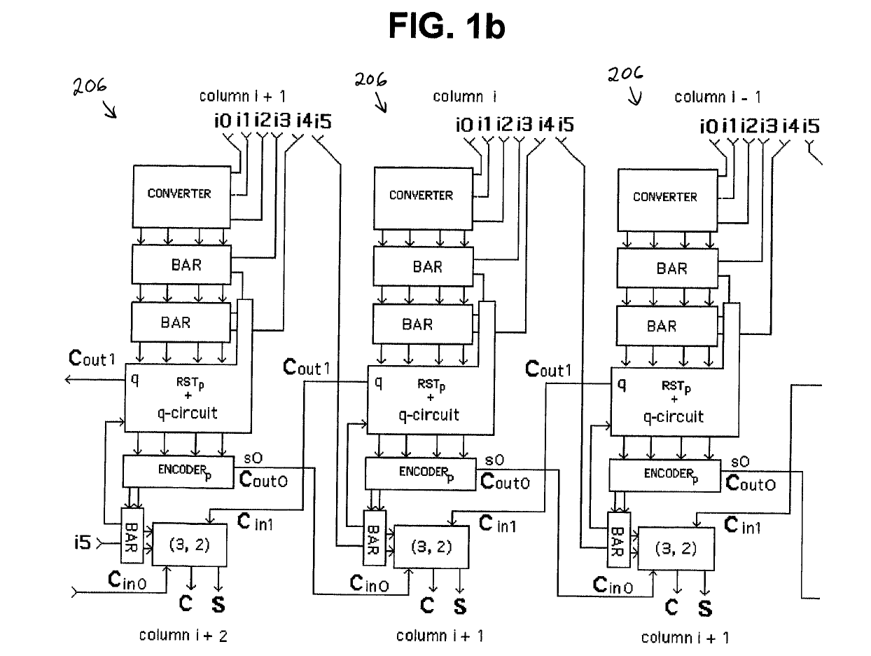

The success of the first feature of the invention relies on the fact that large-size 4-bit state-signal-based shift switch parallel counters can be constructed as exemplified in the (6, 2) parallel counter 206 in FIG. 1. Using these counters in conjunction with smaller innovative shift switch counters, the reduction of between 6 and substantially 9 input bits into 2 bits requires no more delay than that of a prior art parallel counter reducing a maximum of 6 bits into 2 bits (a (6, 2) parallel counter). In effect, the approach reduces 2 or substantially 3 more input bits, making a (8, 2) or even an (9, 2) parallel counter, with no substantial penalty in delay. In contrast, a traditional large binary gate based parallel counter designed to reduce 9 bits into 2 bits (a (9, 2) parallel counter) requires a considerably larger delay than a similar circuit reducing 6 bits into 2 bits. The invention's application of this result is a significantly simpler and faster multiplication-related finctional unit design in CMOS.

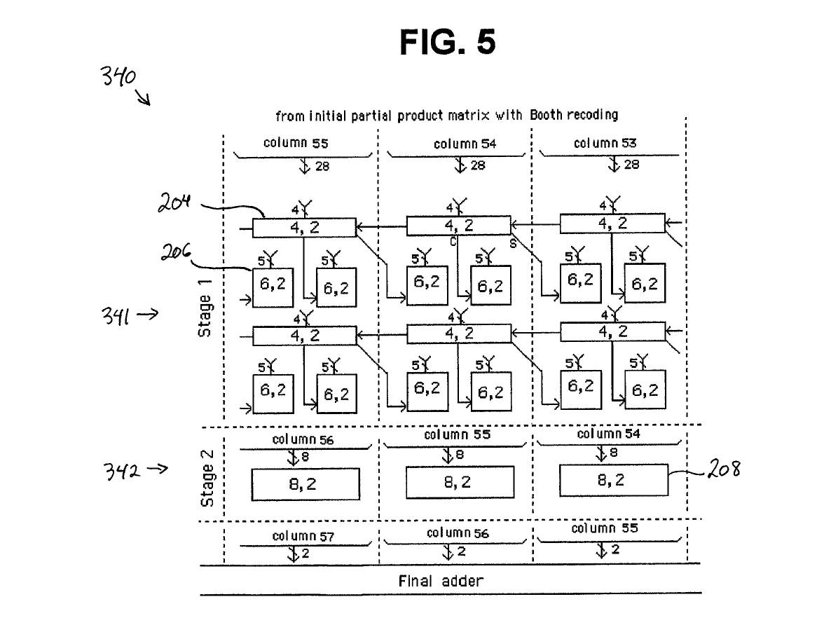

The invention addresses multiplication of two non-floating numbers and multiplication of two floating point numbers. In either case the invention also addresses two sub-cases, one of which operates on full-sized columns of the partial product matrix, and the other of which operates on partial product matrix columns compressed using Booth recoding, a technique well-known in the art. The block diagrams showing the circuits used in each of the four sub-cases appear as FIGS. 5 (Booth-recoded columns, floating point values), 6 (Booth-recoded columns, non-floating point values), 7 (full columns, floating point values), and 8 (fill columns, non-floating point values). The constituent circuits of each block diagram are 4-bit p-type state signal based shift switch parallel counters of sizes ranging from (6, 2) to (9, 2) and small numbers of binary shift switch parallel counters of size ranging from 2 to 4 as shown in all four figures. These shift switch parallel counters are assembled from smaller circuit components. The following description begins with the lowest level of component structure and function, and shows the building up of circuit components into the matrix reduction feature of the invention.

State Signal Representation and Arithmetic

Describing the state-signal-based shift switch parallel counter requires understanding of the representation of state signals and the method of performing arithmetic using state signals. The following paragraphs and the associated figures present a brief summary of these aspects of the invention, and should be used as a reference in the subsequent detailed description of the invention's structure and workings.

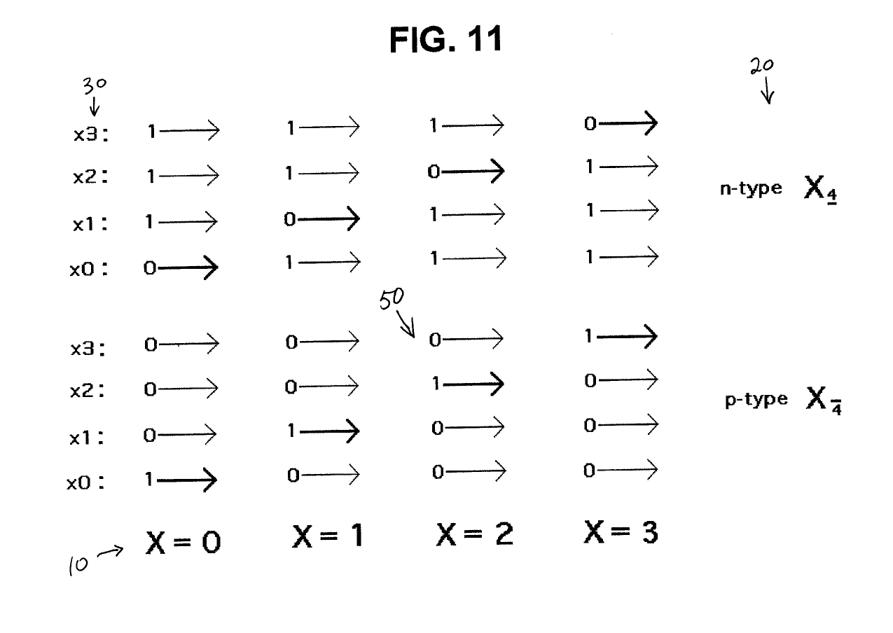

FIG. 11 tabulates the different state signals possible in a 4-bit shift switch circuit. Each state signal listed appears as a column of four bits, one per circuit line, each marked with appended right arrows. In state signal representation, only one bit has a setting opposite to that of the other three, and the position of the unique bit with opposite setting maps one-to-one to a unique numeric value. Bottom row 10 shows the numeric value of the signals above it. Right column 20 shows two alternative methods of representation using 4-bit state signals: n-type, in which the bit with the unique setting is 0; and p-type, in which the bit with the unique setting is 1. Left column 30 shows the identifiers used for the circuit lines. The state signal for the value 2 in a p-type 4-bit state signal circuit appears at intersection 50 of the column having X=2 in bottom line 10 and the row having the words “p-type” in right column 20. The state signal value at intersection 50, reading from x3 to x0, is (0 1 0 0). Left column 30 shows that the single bit set to 1 for the value 2 is on line x2.

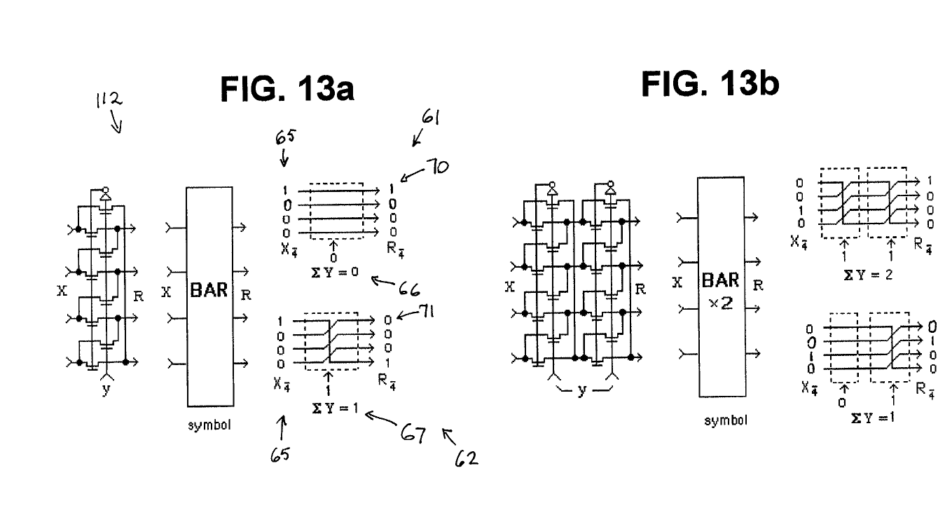

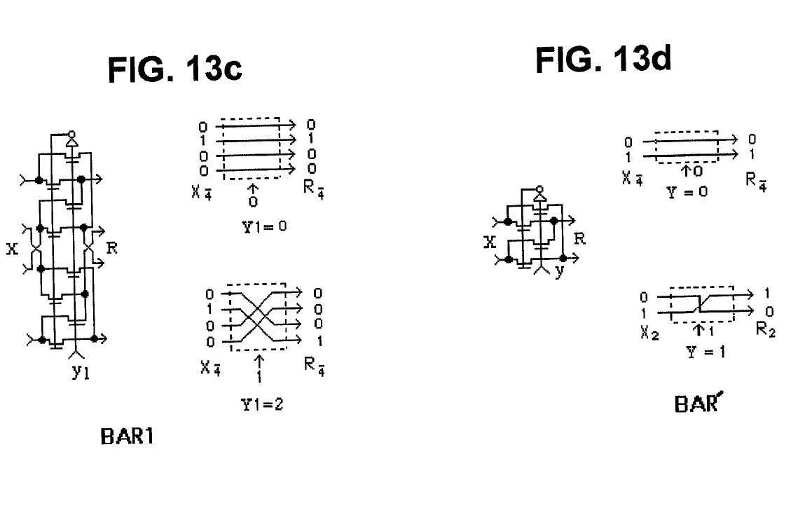

Addition using state signals is performed as exemplified in FIGS. 13a through 13d. Each of these figures shows at the left a shift bar circuit, next its block-diagram circuit symbol, and at the upper and lower right a pair of different addition examples for that circuit. These and other similar circuits comprise components of the invention. For simplicity of presentation of state signal addition, the invention's propagation and processing of carry bits is omitted in these four illustrations.

FIG. 13 a shows a single exemplary shift bar circuit 112 which adds one input bit signal, also called a control bit, to an input p-type state signal 65, labeled x₍₄₎. The value of state signal 65 is (1 0 0 0), or 3, as can be seen by referring to FIG. 11. Two alternative cases 61 and 62 are shown. In case 61, input control bit signal 66, which has the value 0, is added to input state signal 65. In this case, the shift bar circuit leaves unchanged the paths for input state signal 65, and input state signal 65 appears as output state signal 70, labeled r₍₄₎. The value of state signal 70 is 3, the same as that of input state signal 65a. This illustrates the arithmetic operation 3+0=3.

In case 62, input control bit signal 67, which has the value 1, is added to input state signal 65. In this case, the shift bar circuit shifts the paths for input state signal 65 as shown, so that the single bit with the unique setting now moves to the bottom position, in circular fashion. The result appears as output state signal 71, labeled r₍₄₎. The value of state signal 71 is one more than that of input state signal 65:3. This illustrates the modular arithmetic operation 3+1=0.

The circular movement of signals upward and then to the bottom of the set of signal lines produces a result which is also called a modulo-4 sum. The term “modulo-4” means that any result which would result in an output value larger than can be represented with a 4-bit state signal is, by the design and implementation of the circuit, “wrapped around” as if the value 4 were subtracted from that result one or more times so as to yield a result in the range of 0 to 3. The wrapping around of a bit signal with the value 1 triggers a separate “carry” signal output, for use in other circuits as required.

FIG. 13b illustrates an exemplary shift bar circuit which performs two input bit additions to an input state signal; in different components and embodiments, the invention performs several such additions using a single input state signal. Circuits for such components and embodiments are presented below.

FIG. 13c shows an exemplary shift bar circuit for performing the addition of an input control bit to an input state signal where the input control bit signifies the value 2 instead of 1. This has the effect of circularly shifting the state signal by two, rather than one, positions, effectively incrementing it by two.

FIG. 13d illustrates an exemplary shift bar circuit for performing addition on a 2-bit, rather than a 4-bit, input state signal.

In general, the invention's components and embodiments comprise numerous variations on, and combinations of, the circuits just described; these components and embodiments are described below.

The Shift Switch Parallel Counter Circuit

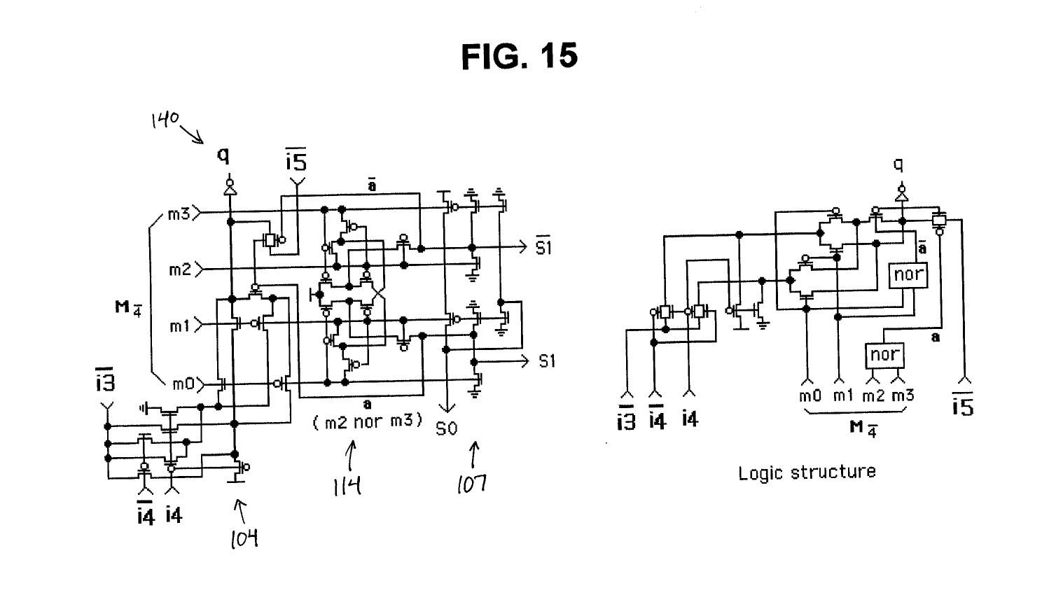

FIG. 1 shows a typical 4-bit, state-signal-based, shift switch (6, 2) parallel counter circuit 206. Its sub-circuits are named and are illustrated in the block diagram in FIG. 1 a. The connection of counters 206 in three contiguous columns of weights i−1, i, and i+1 is illustrated in FIG. 1b. Note that the two output bits, sum S and carry C, from the (6, 2) counter 206 of column i are for column i+1. Two dotted lines in FIGS. 1 and 1a show the major components of (6, 2) parallel counter 206, with processing flowing principally from left to right. The components comprise an input converter 102, a compressor 105, and a full adder 203. Compressor 105 in turn comprises two shift BAR circuits 112a and 112b, a restoration circuit 114, a carry circuit (q-circuit) 104 (refer to FIG. 15), an encoder circuit 107, and a shift BAR′ circuit 113.

It is important to remember that the binary inputs to a shift switch parallel counter are not bits related to each other as a single number, but are input bit signals to be counted. This means that if signals appear on i0 and i1 but not i2, the count of signals is two, just the same as when signals appear on i1 and i2 but not on i0, or on i0 and i2 but not on i1. A signal with a weight of 2, then, counts as two signals. The task of the parallel counter is, simply, to count the total number of input signals and produce a sum and any necessary carries.

Input converter 102 (also called a one-hot encoder) translates binary inputs i0, i1, and i2 into state signals 120, and passes them to compressor 105. Shift BARs 112a and 112b of compressor 105 adds 2 binary bit signals i3 and i4 to state signals 150. Compressor 105 encodes state signal 150 into sum bit s0 and a dual-rail carry bit s1. Shift BAR′113 of compressor then adds binary input bit i5, which has a weight 2, to the carry bit s1 resulting in an input (a level swing bit) to the full-adder 203 (which can restore the swing signal without any additional cost). Meanwhile, restoration circuit 114 of compressor 105 brings the signal level of the state signals 150 up to its input level and a q bit (the carry with a weight of 4) is generated by the q-circuit 104 (refer to FIG. 15). The full adder 203 takes the other two input bits, Cᵢₙ₀ and Cᵢₙ₁, from the columns adjacent to the column where the subject (6, 2) counter 206 is situated, one from the left, the other from the right. The final output, a binary number S and C is produced by the full adder.

This provides a summary of the counter's structure and operation. Detailed descriptions follow.

The Input Converter

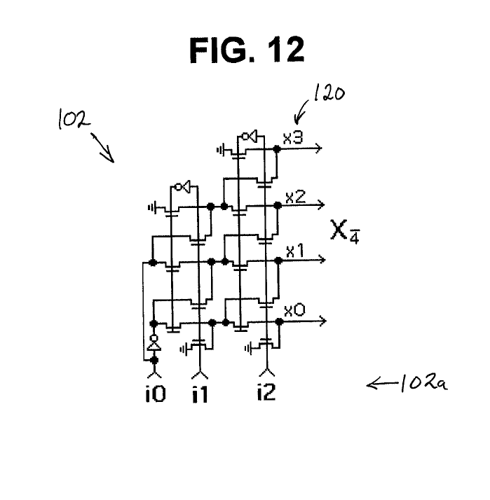

Refer to FIG. 12. A binary-to-state-signal converter 102 turns three independent binary input signals 102a, one each on lines i0, i1 and i2 into a 4-bit state signal 120, called X, comprising one bit on each of lines x0, x1, x2, and x3.

The state-signal encoding of binary values insures that regardless of the input value supplied, there will be only one bit set at all times, which completely levels the electrical power demand for all four possible state signals. In a typical binary-arithmetic circuit, more or fewer bits would be set from one number value to another, and the power would normally change significantly as stored number values change. The invention's leveling out of the power demand using state signals as described constitutes a significant advantage over conventional techniques.

For the arithmetic operation of input converter 102, see FIGS. 1 and 1a. The value of the state signal 120 supplied by the bits (x0 x1 x2 x3) ranges from 0 to 3, and it is defined as i, given that x(i) is the unique bit. Converter 102 in FIG. 1 produces

i1+i2+i3=X

where X is state signal 120 comprised of bits (x0 x1 x2 x3). The converter feeds state signal 120 to C2 compressor 105.

The C2 Compressor

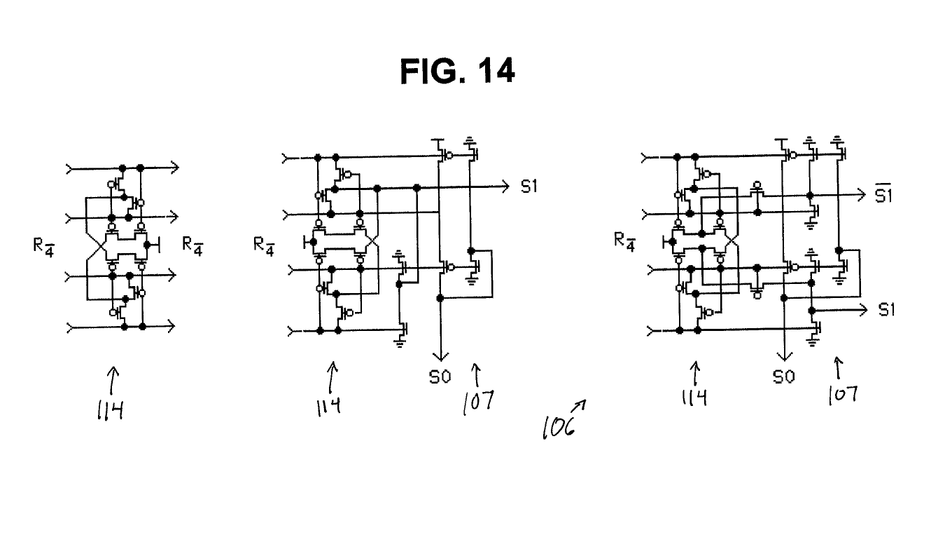

See FIGS. 1 and 1a. C2 compressor 105 comprises six sub-circuits: two shift BAR circuits 112a and 112b, one signal restoration (RST) circuit 114, an encoder circuit 107, a variant shift bar circuit 113, and a carry-processing circuit (q-circuit) 104 (see FIG. 15). The combined carry-processing circuit 104, restoration circuit 114, and encoder 107 and their logic structure are illustrated in FIG. 15. The composition of the combined restoration circuit 114 and encoder 107 are shown in FIG. 14.

C2 compressor 105 combines the converter's state signal input 120, called X and labeled as bits (x0 x1 x2 x3), with two independent input binary bits, labeled i3, and i4, to produce two outputs. The first output is a state signal 150, called M and labeled (m0 m1 m2 m3), which is a modulo-4 sum. The second output 140 is a binary bit q, called a carry bit. C2 compressor 105 performs a modulo-4 arithmetic operation so that

X+i3+i4+2*i5 MOD 4=M=s0+2*s1; and q=FLOOR(X+i3+i4 +2*i5)/4),

Where FLOOR represents the rounding-down function. In simpler terms,

X+i3+i4+2*i5=M+4q=s0+2*s1+4q

where q is only set to 1 whenever the sum X+i3+i4+2*i5 is greater than 3.

Full adder 203 performs an addition so that

s1+Cin1+Cin0=S+2*C

Thus the complete algebraic equation for the shift switch (6, 2) parallel counter is as

X+i3+i4+2*i5+2Cᵢₙ₀+2Cᵢₙ₁=s0+2*S+4*C+4q

The logic here applied by C2 compressor 105 is a form of 4-bit shift switch logic, as outlined earlier in the section concerning state signal arithmetic. In compressor 105, the circuits other than q-circuit 104, including shift BARs 112a and 112b, restoration circuit 114, encoder 107, and shift BAR 113 perform a modulo-4 sum operation. The q-circuit 104 (see FIG. 15), produces a carry bit 140, labeled q, with a weight of 4. The weight of 4 means that when carry bit q is set, it signifies the value 4.

Restoration circuit 114, q-circuit 140, and encoder 107 are shown in detail in FIG. 15. They perform their logic operations as follows. Input state signal 120, called X, produced by converter 102, passes through two shift BARs 112a and 112b which shift the state signal 120 (X) according to input control bits i3 and and i4, one control bit per BAR. When an input state signal passes through a shift BAR, the resulting state signal has a value equal to the modulo-4 sum of the state signal and the control bit. As in many typical pass-transistor circuits, the resulting state signal contains level-swing signal bits, meaning that the output state signal levels are lower than the input state signal levels. A p-type restorer circuit labeled RSTp in FIG. 1a, has eight reduced-size pMOS transistors that restore the state signals to their input levels.

The q-circuit 104 of FIG. 15 generates a carry bit q of weight 4 based on the following logic equations:

q=i3 OR i4 if M=0; (1)

q=i3 AND i4 if M=1; (2)

q=i5 if M=2 or 3; (3)

simply,

q=(i3+i4>M) or (2*i5+M>3)

which can be translated into binary logic (with the circuit implemented by pass transistor logic) as:

q=(i3+i4)(m0)+(i3)(i4)(m1)+(i5)(m2+m3)

The Encoder The encoder circuit 107 completes the preparation of compressor 105 outputs. Circuit 107 encodes the state signal into binary signals in parallel with the restoration, to produce two bits S1 and S0 such that

2s1+s0=R.

This completes the description of the invention's shift switch (6, 2) parallel counter 206.

A primary advantage of the invention's high-speed (6, 2) parallel counter 206 is its low-power logic structure, derives principally from the following specifics. First, the p-type 4-bit state signal based CMOS circuit can reduce its transistor's logic transitions significantly during an operation, because no more than half (or 2 out of 4) of the signal bits are subject to value-change at any logic stage. Second, three out of four state signal bit-paths propagate 0 bits, but only one path propagates a 1 or level-high signal bit. Leakage current occurs only in the area occupied by level-high signals. With the invention, only a quarter of the state signals are level-high signal bits, as compared to about half of the signal levels for a binary logic circuit. The invention's unique logic structure leads to a significantly smaller leakage power dissipationthan in conventional CMOS style circuits. Third, the riMOS pass transistor (low-power device) is the dominant circuit, and it contains only 11 inverters (the major power elements), significantly fewer than conventional (3, 2)-(4, 2) counter based designs wherel6 or more inverters are usually required.

Another important advantage of the invention's (6, 2) parallel counter 206 is its organization. The counter allows input binary signals i4 and i5 (particularly i5) to arrive later than the input signals i0, i1, i2, and i3, with an acceptable delay equal to that of a full-adder or even a (4, 2) counter. Late arrivals of these bits do not substantially increase the time required by the invention's (6, 2) counter 206 to produce its outputs S and C. This advantage is a highlight of the invention's shift switch (6, 2) parallel counter's high performance in all aspects of VLSI design.

To restate and summarize, all conventional binary-gate-based parallel counters use their input bits in full parallel fashion to reduce delay. In contrast, the invention's counter is based on shift switch logic. It relies on fast and simple state signal propagation that carries out the computation, to achieve high speed. Though the propagation of state signals is sequential in nature, the invention achieves its own parallelism by the concurrent processing of all bits of the 4-bit state signal.

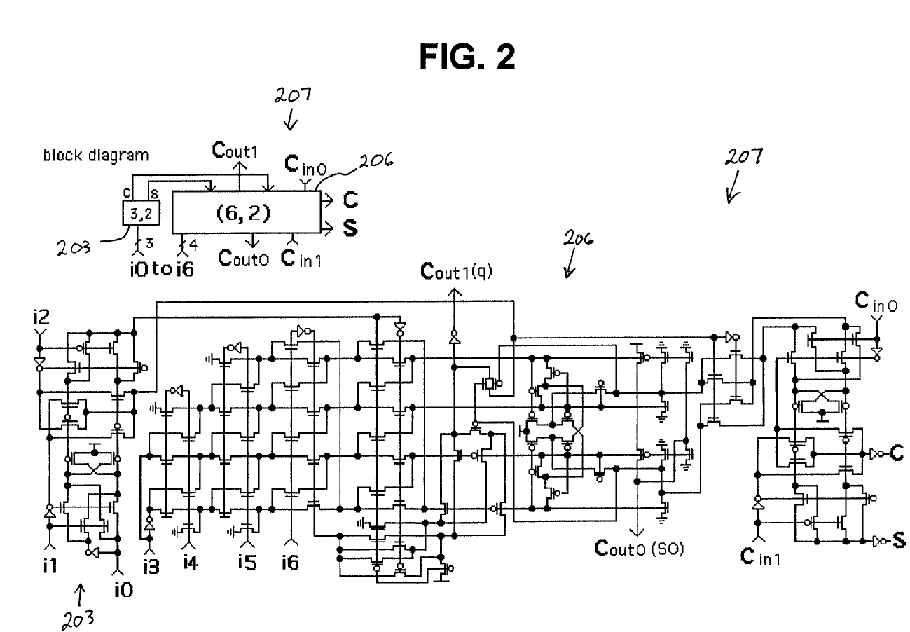

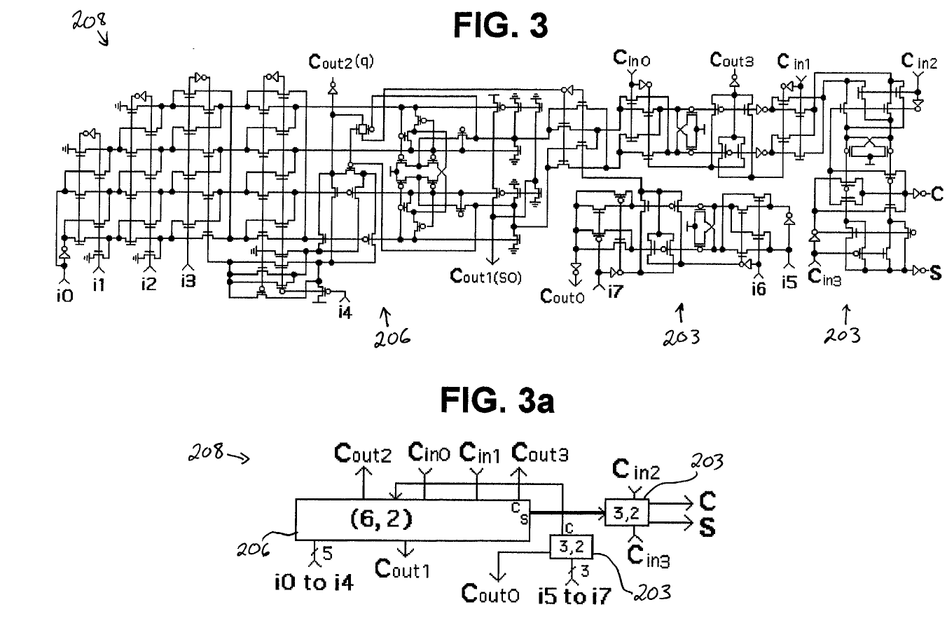

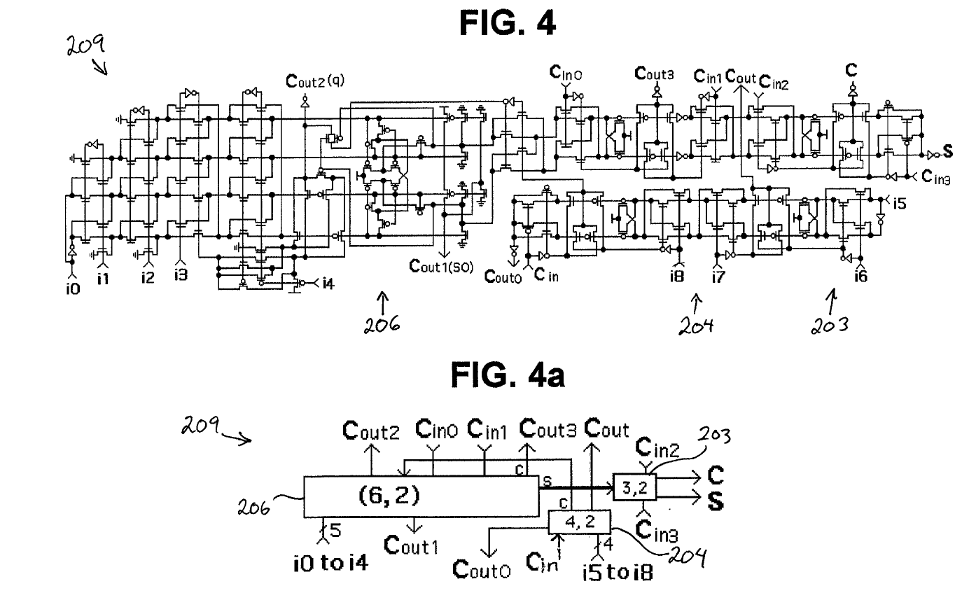

Such a combination of advantageous features—pass-transistor-type arithmetic processing coupled with 4-bit parallelism—allows utilization of late-tolerance input bits in the invention's three larger parallel counters, the (7, 2) parallel counter 207 shown in FIG. 2, the (8, 2) parallel counter 208 shown in FIG. 3, and the (9, 2) parallel counter 209 shown in FIGS. 4 and 4a, without substantial adverse effects on circuit performance.

Additional Fast Counter Circuits

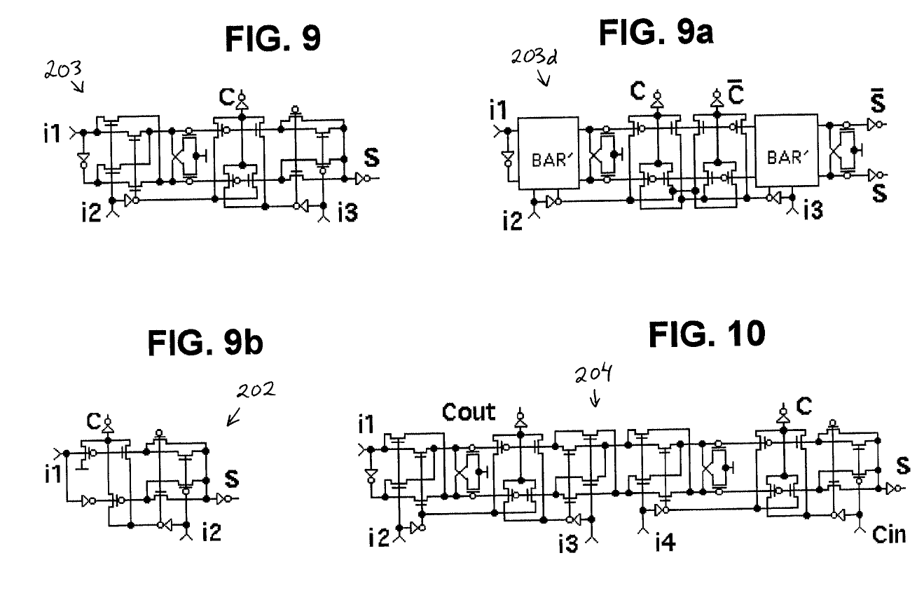

To expand the usefulness of the invention's shift switch (6, 2) parallel counter 206 in building larger counters for its matrix reduction circuitry, the invention incorporates several smaller shift switch circuits in a preferred embodiment. These circuits include a new full adder, or (3, 2) counter 203, shown in FIG. 9; a dual-rail (3, 2) counter 203d in FIG. 9a; and a new (4, 2) small parallel counter 204, shown in FIG. 10, all using a differential signal swing restoration circuit. The new full adder or (3, 2) counter 203, as shown in FIG. 9, has a minimum transistor count of 24, but it is significantly faster than other embodiments of the same size.

A minimum-size shift switch (4, 2) parallel counter 204, as shown in FIG. 10, consisting of only 44 transistors (4 fewer than the one reported in [ ]), is directly derived from the tiny full adder. The formula for the (4, 2) counter: [(4,2) counter: i0+i1+i2+i3+Cin=S+C+2*Cout. The tiny (3, 2) and (4, 2) counters 203 and 204 are utilized in various multiplier embodiments for reducing bits when larger counters are not necessary. The formula for the (3, 2) counter: i0+i1+i2=S+2*C. The formula for the (2, 2) counter: i0+i1=S+2*C. The tiny (3, 2) and (4, 2) counters 203 and 204 are also significant in their own right for the designs of (3, 2) and/or (4, 2) based traditional multipliers.

Larger High-Speed Counters

To achieve faster multiplication, the invention combines the shift switch (6, 2) parallel counter 207 and the smaller counters just described in its implementations of fast (7, 2), (8, 2) and (9, 2) counters 207, 208 and 209 for use in partial product matrix reduction. In contrast to conventional circuits, these counters show that there is only a small delay increase when a counter's input bit increases by one. In other words, the delay increase from counter (n, 2) to counter (n+1, 2), for any n=6 to 8, is significantly smaller than that for the corresponding binary gate based counters. This reduction of the delay increase is a significant improvement on conventional designs, and is consequently an advantage of the invention. FIGS. 2 through 4 show the respective structures of these counter circuits, and Table 1 summarizes their size, speed and features of the component devices.

Refer to FIG. 2. The invention's (7, 2) counter 207 consists of a (6, 2) counter and a full adder 203 which accepts three input bits of the (7, 2) counter as its own inputs. The two output bits, sum s and carry c, of the full adder then become two input bits i4 and i5 of the (6, 2) counter respectively (see FIG. 1). Note that the carry bit c of the full adder has the same weight as that required by i5. This arrangement produces little change in delay in the integrated operation of the shift switch (7,2) counter 207, so that all 7 input bits of weight 1 are processed efficiently. The (7,2) counter formula: i0+i1+i2+i3+i3+i4+i5+i6+2Cin0 +2Cin1=Cout0+2*S+4*C+4Cout1.

Refer to FIG. 3. The invention's (8, 2) counter 208 consists of a (6, 2) counter and two full adders 203. The first full adder accepts three input bits of the (8, 2) counter as its own inputs. The carry output c of the full adder then become input i5 of the (6, 2) counter, refer to FIG. 1. Note that the carry bit c has the same weight as that required by i5. The other full adder connects its inputs with the lower and higher neighbor columns as shown in FIG. 3. This arrangement produces little change in delay in the integrated operation of the shift switch (8,2) counter 208, so that all 8 input bits of weight 1 are processed with little more delay than a counter 207. The (8,2) counter formula: i0+i1+i2+i3+i4+i5+i6+i7+2*Cin0+2*Cin1+2*Cin2+2*Cin3=2S+4C+Cout0+Cout1+4*Cout2+4*Cout3.

The invention's (9, 2) counter 209 is constructed as shown in FIG. 4. It is an (8, 2) counter 208 except that the first full adder of the 208 is replaced by a (4, 2) counter 204. The (4, 2) counter accepts four input bits of the (9, 2) counter as its own inputs. The (final) carry output c of the full adder then become input i5 of the (6, 2) counter (see FIG. 1). Note that again the carry bit c has the same weight as that required by i5. This arrangement produces little change in delay in the integrated operation of the shift switch (9,2) counter 209, so that all 9 input bits of weight 1 are processed with little more delay than a counter 208. The (9,2) counter formula. i0+i1+i2+i3+i4+i5+i6+i7+i8+2*Cin0+2*Cin1+2*Cin2+2*Cin3+Cin=2S+4C+Cout0+Cout1+4*Cout2+4*Cout3+2*Cout.

Performance And Configuration Summary

Table 1 summarizes the circuits features and simulation. Refer to the prior work of G. Goto, A. Inoue, R. Ohe, S. Kashwakura, S. Mitarai, T. Tsuru, and T. Izawa, A 4.1-ns compact 54×54-b multiplier utilizing sign-select Booth encoders, IEEE Jourrnal of Solid-State Circuits, Vol. 32; No 11, November 1997. Note that Area Equivalent is for equivalent minimum transistor count with nMOS=1, pMOS=3, minimum pMOS=1; average power values are used for the power comparisons. Delay and power simulations are based on widely-accepted modeling projections. The delay is for the worst case delay among all inputs to all outputs.

TABLE 1

| | | | | | | | Prior |
|---|---|---|---|---|---|---|---|
| | | | | | | | Work |
| | The invention | | | | | | (see text) |
| Counter Type | (6, 2) | (7, 2) | (8, 2) | (9, 2) | (3, 2) | (4, 2) | (4, 2) |
| Full Adder | 4 | 5 | 6 | 7 | 1 | 2 | 2 |
| Equivalent (FE) | | | | | | | |
| Transistor Count | 101 | 121 | 147 | 165 | 24 | 44 | 48 |
| Delay (ns) | 1.15 | 1.30 | 1.35 | 1.40 | 0.38 | 0.69 | 0.73 |
| Area Equivalent | 117 | 142 | 177 | 198 | 32 | 56 | 69 |
| nMOS/pMOS | 1.80 | 1.73 | 1.67 | 1.71 | 1.18 | 1.44 | 1.00 |
| Power Dissipation | 2.9 | 3.8 | 4.9 | 6.3 | 1.2 | 2.1 | 3.1 |
| 10⁻⁶ | | | | | | | |
| (W/MHz 2.5 − V) | | | | | | | |
| Inverter Count | 11 | 14 | 20 | 22 | 5 | 8 | 9 |
| nMOS | 65 | 76 | 92 | 104 | 13 | 26 | 24 |
| pMOS (regular) | 11 | 14 | 20 | 22 | 5 | 8 | 14 |
| pMOS (small) | 25 | 31 | 35 | 39 | 6 | 10 | 10 |
| Area Equivalent/ | 29.4 | 28.4 | 29.5 | 28.3 | 31.5 | 28.0 | 34.5 |
| FE | | | | | | | |
| Power/FE | 0.73 | 0.76 | 0.82 | 0.90 | 1.2 | 1.05 | 1.55 |
| Inverters/FE | 2.75 | 2.8 | 3.3 | 2.4 | 5 | 4 | 4.5 |
| nMOS/pMOS | 1.80 | 1.73 | 1.67 | 1.71 | 1.18 | 1.44 | 1.00 |

Partial Product Matrix With Shift Switch Counters

The speedup of the reduction of a multiplier's partial product matrix is accomplished by the innovative combination of counter circuits described above. Specific arrangements of the circuits differ according to whether or not the numbers being multiplied are floating point numbers, and according to whether or not the multiplier itself employs Booth recoding to reduce the size of the partial product matrix. The following paragraphs describe the invention's partial product matrix reductions for each of the four cases arising from these alternatives.

Floating-point Number Multiplication with Booth Recoding

Refer first to FIG. 5, which shows the invention's circuit network 340 for floating-point number multiplication where Booth recoding is used. Since multiplication time scales with the number of additions performed, the critical paths in this multiplication are those involving the largest number of bits to be added. Here the critical paths involve columns 53, 54, and 55 as shown in FIG. 5. The design is based on the use of the (6, 2) counter 206 of FIG. 1 and the (8, 2) counter 208 of FIG. 3, and requires only two stages of sum reduction. The number of initial partial product bits on these three columns is the maximum among all 108 columns: 28 per column. This number results from the use of well-known Booth recoding circuits, not shown here.

The first stage 341 (shown as Stage 1) of the network 340 reduces this number of bits to 8 by using four (6, 2) shift switch counters 206 and two (4, 2) counters 204 in parallel. The second stage 342 (Stage 2) of the network further reduces the number of bits to 2 in each column by using a single (8, 2) parallel counter 208, which sends the outputs to a fast final adder (not shown). The delay of the process excluding final addition found through simulation (with 0.25 micron, 2.5 v supply process) is less than 2.5 ns, which is superior to well-known (4, 2) (3, 2) based 4-stage/7-stage schemes resulting in 2 bits in 2.7 ns by the same simulations. Note that here the inter-connection delays, which favors the present invention having 2 stages instead of 4/7 stages, were not counted.

Non-floating-Point Number Multiplication with Booth Recoding

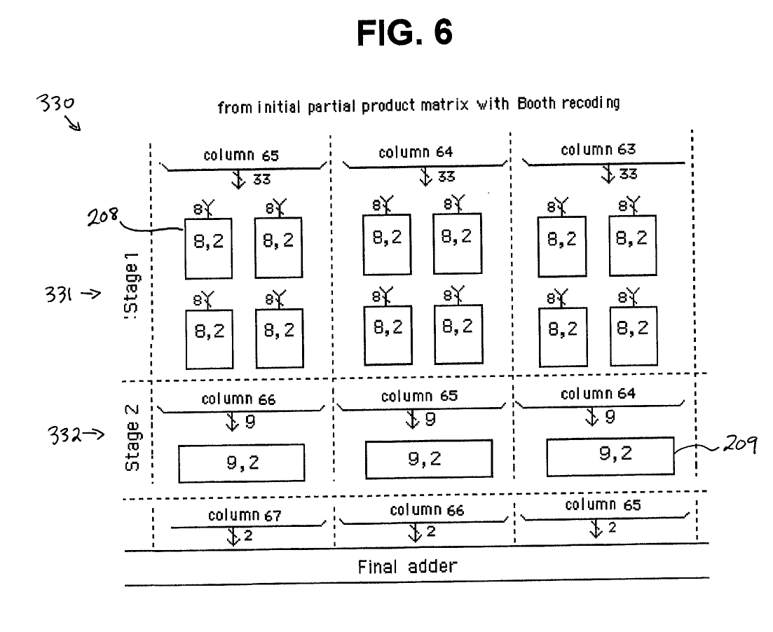

Refer next to FIG. 6, which shows the invention's circuit network 330 for 64-bit non-floating multiplication where Booth recoding is used. The critical paths in this multiplication are those involving the largest number of bits to be added. Here the critical paths involve columns 64, 65, and 66, as shown in FIG. 6. The design is based on the use of the (8, 2) counter 208 of FIG. 3 and (9, 2) counter 209 of FIG. 4, and requires only two stages of sum reduction. The number of partial product bits on these three columns is the maximum among all 128 columns: 33 per column. As in the previous description, this number results from the use of well-known Booth recoding circuits, not shown here.

The first stage 331 of the network reduces this number of bits to 9 by using four (8, 2) shift switch counters 208 of FIG. 3. The second stage 332 (Stage 2) of the network further reduces the number of bits to 2 in each column by using a single (9, 2) parallel counter 209, which sends the outputs to a fast final adder (not shown). The delay of the process excluding final addition found using the same process as described above is less than 2.75 ns, which is superior to well-known (4, 2)/(3, 2) based 5-stage/8-stage schemes resulting in 2 bits in 3.05 ns. Note that again here the inter-connection delays, which favors the present invention having 2 stage instead of 5/8 stages, were not counted.

Floating Point Number Multiplication Without Booth Recoding

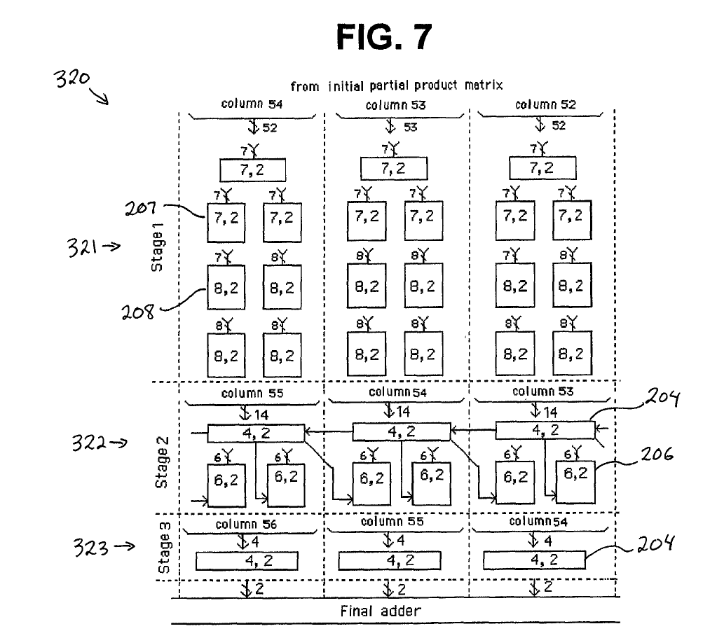

Refer to FIG. 7, which shows the invention's circuit network 320 for floating-point multiplication where Booth recoding is not used. The critical paths involve columns 52, 53, and 54 as shown, and are composed of three stages. The first stage 321 (Stage 1) reduces 53 bits to 14 bits by using four (8, 2) 208 and three (7, 2) shift switch counters 207 as depicted in FIG. 4 and FIG. 3 respectively. The second stage 322 (Stage 2) reduces 14 bits to 4 bits by using two (6, 2) shift switch counters 206 and a (4, 2) counter 204. The third stage 323 (Stage 3) reduces 4 bits into 2 bits by using a single (4, 2) counter 204. The simulation shows a total delay of 3.2 ns, in contrast to a (4, 2) (3, 2)-based scheme which requires 5/9 stages and 3.4 ns. The inter-connection delays are not counted.

Non-floating Point Number Multiplication Without Booth Recoding

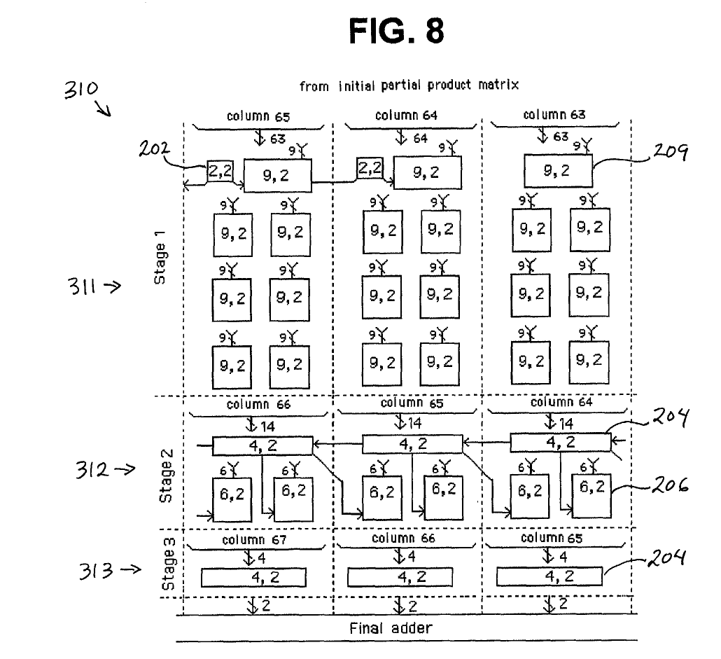

Refer next to FIG. 8, which shows the invention's circuit network 310 for non-floating point number multiplication where Booth recoding is not used. The critical paths involve columns 63, 64, and 65 as shown, and are composed of three stages. The design is the same as that for floating point number multiplication where Booth recoding is not used, seen in FIG. 7, except that the first stage 311 (Stage 1) reduces 64 bits into 14 bits by using seven (9, 2) shift switch counters 209 and a (2, 2) shift switch counter 202 as depicted in FIG. 4 and FIG. 9b respectively. The remaining stages 312 and 313 are arranged the same as in FIG. 7. The simulation shows a total delay of 3.25 ns, in contrast to a (4, 2)/(3, 2)-based scheme which requires 5/10 stages and 3.45 ns. The inter-connection delays are not counted.

This concludes the description of the first major features of the present invention: the shift-switch-based counter circuit family, and the family of partial product matrix reduction circuits.

A Low Power Highly Regular Parallel Multiplier Design

The second major feature of the invention is a low power highly regular parallel multiplier design. The invention's unique approach is called “square recursive decomposition.” Just as for its design of the shift-switch-based partial product matrix reduction circuit, the invention here uses low-power high-performance counter circuits based on a non-binary shift switch logic which is the subject of U.S. Pat. No. 6,125,379, incorporated herein by reference. Thanks in part to the advantages conferred by these innovative counter circuits, the invention's parallel multiplier design achieves better performance in speed, reduced VLSI area, and reduced power dissipation than is found in existing designs.

The invention's multiplier is now described from three points of view: first, the multiplier organization and behavior; second, the circuit architecture; and third, the essential circuit implementations.

The Multiplier's Organization And Behavior

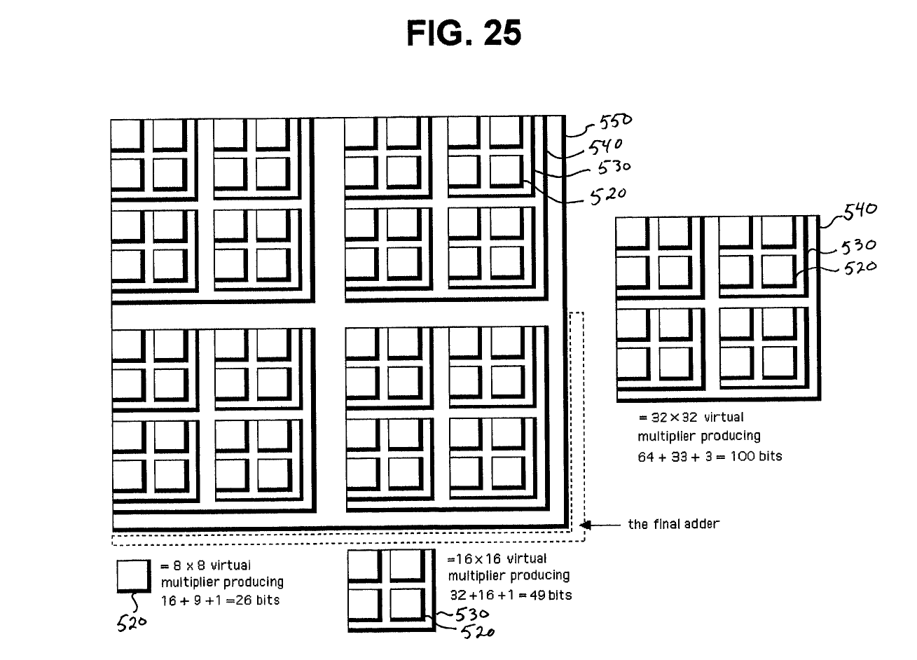

See FIG. 25. The invention's 64×64-bit parallel multiplier 550 shows the following three distinctive features: distribution of the multiplication input bits into multiple small partial product matrices, assembly of product results through four stages of bit reduction, and generation of the final product requires a simpler final adder circuit than other existing designs. FIG. 25 shows the highest-level view of the multiplier 550 and the nesting of its component smaller multiplier circuits 540, 530 and 520, leaving out the interconnection and circuit details.

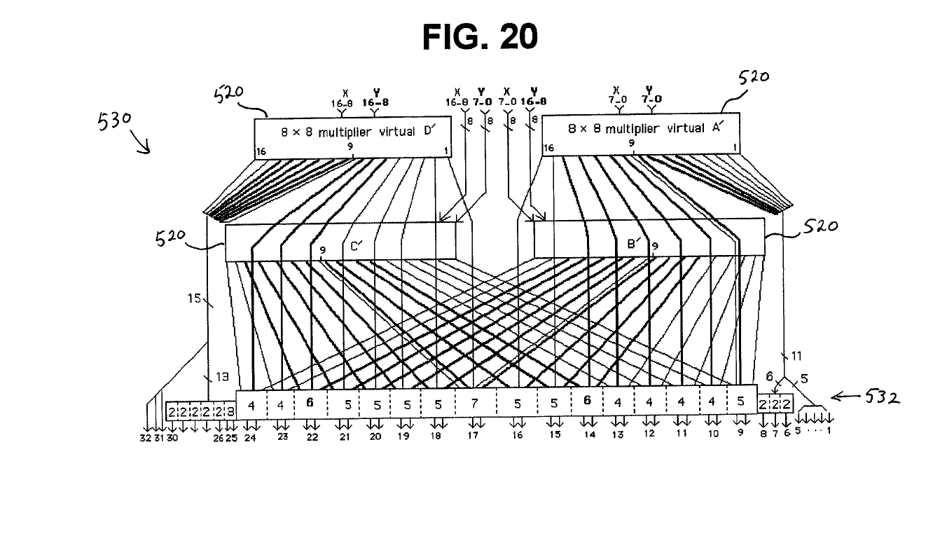

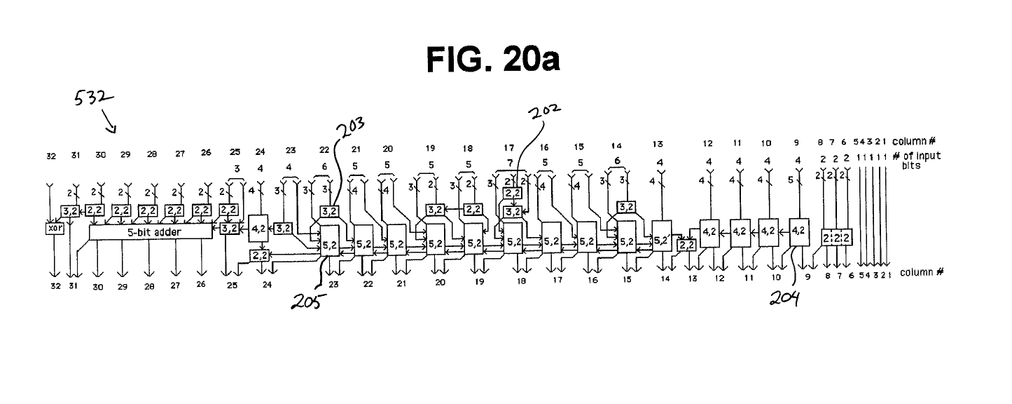

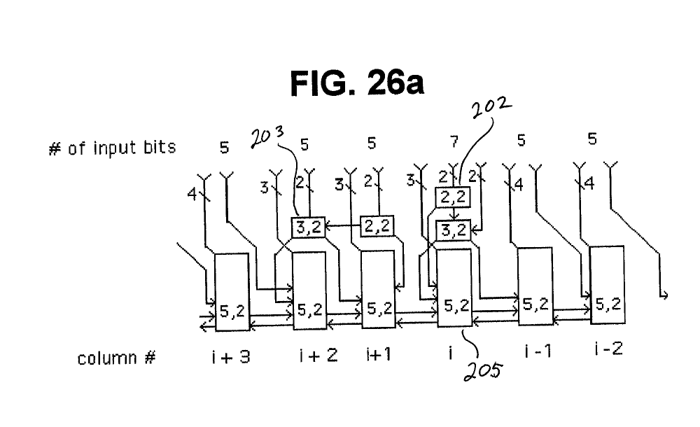

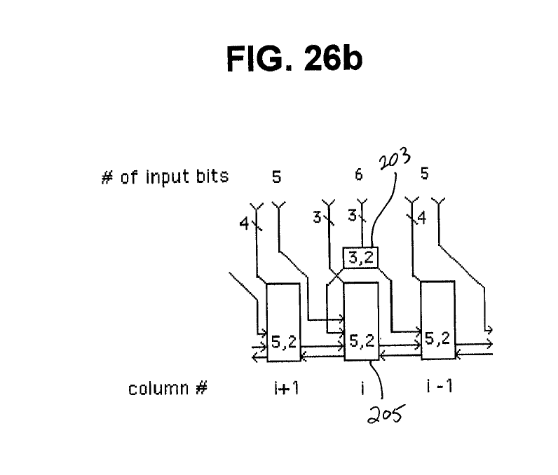

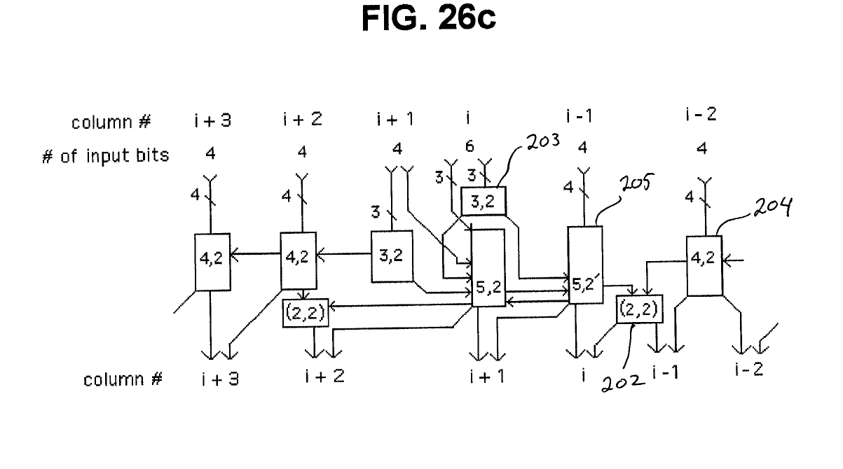

For a closer look at the details of inter-column connections, see FIGS. 26a, 26b, and 26c. FIG. 26a shows the bit reduction case for the (5, 2) based shift switch counter array of FIG. 20a where a column with 7 input bits connects with its adjacent lower and higher neighbor columns, each with 5 input bits. FIG. 26b shows the bit reduction case for the (5, 2) based shift switch counter arrays of FIG. 20a where a column with 6 input bits connects with its adjacent lower and higher neighbor columns, each with 5 input bits. FIG. 26c shows the bit reduction case for the (5, 2) based shift switch counter array of FIG. 20a where a column with 6 input bits connects with its adjacent lower and higher neighbor columns, each with 4 input bits.

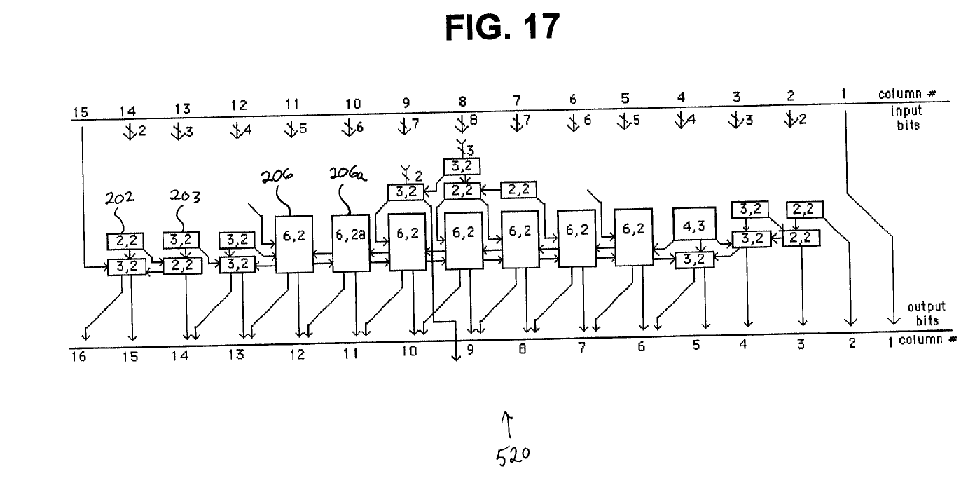

Refer to FIGS. 17 and 25. For its first feature, the invention's multiplier 550 distributes input bits to 64 small multipliers 520, using a full 4-branch tree structure and generating 8×8-bit partial products at each location. This supplants the use of a single large partial product matrix as commonly adopted by conventional designs, including those with Booth recoding.

For its second feature, the invention's multiplier 550 comprises four stages of bit reductions, each corresponding to a sub-multiplication module as follows. Refer to FIG. 25. At the first stage, virtual multiplier 550 contains 64 identical 8×8-bit small parallel multipliers 520, each adding up the 64 weighted partial product bits to produce 26 bits, using shift switch parallel counters with the core part consisting of six (6, 2) parallel counters 206 and a binary counter (6, 2)a, as shown in FIG. 17. The output bit distribution is as follows: one bit each for columns 1 to 5, 15 and 16, two bit each for columns 6 to 14 except column 9 which produces 3 bits. The formula for the (6,2)a counter: i0+i1+i2+i3+i4+i5+2*Cin0+2*Cin1=2*S+4*C+Cout0+4*Cout1]

See FIG. 20. At the second stage, virtual multiplier 550 groups these 8×8-bit multipliers by fours into 16 identical arrays of 16×16-bit small virtual parallel multipliers 530, each adding up the 10 weighted partial product bits to produce 49 bits, using a shift switch parallel counter array 532 with the core part consisting of ten (5, 2) parallel counters 205, as shown in FIGS. 20 and 20a. Note that a bold line represents two bits in in FIGS. 20 to 22. FIG. 20a illustrates the circuit diagram of the shift switch counter array of the virtual multiplier, which adds up the input partial product bits, producing 49 output bits. The output bit distribution is as follows: one bit each for columns 1 to 8, 26 to 30, and 32, two bits each for the remaining columns.

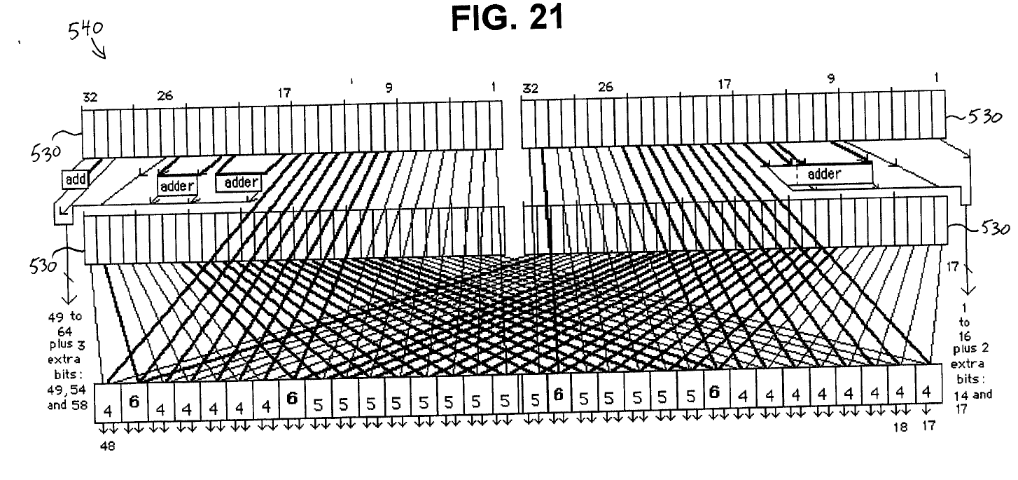

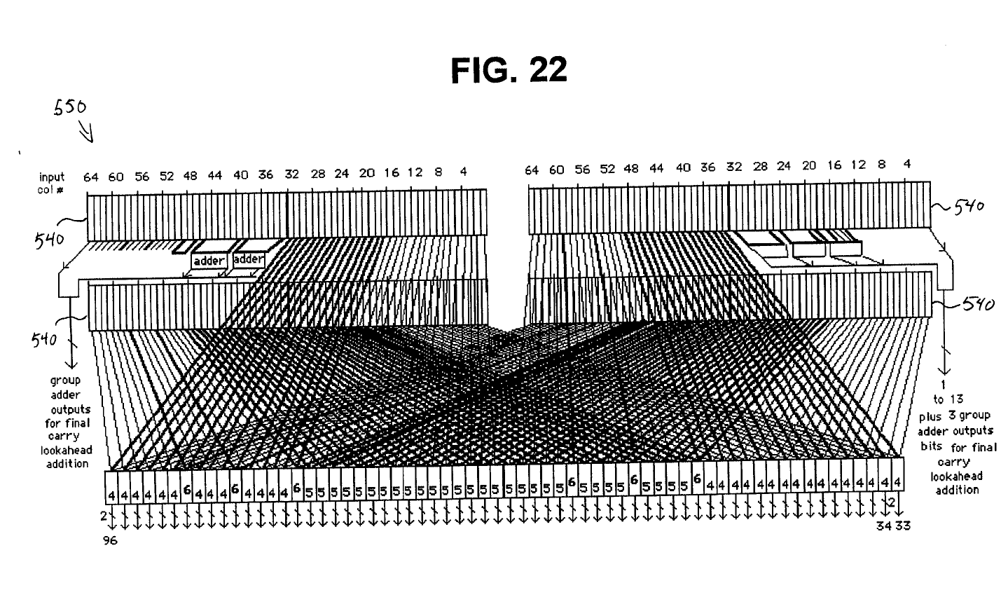

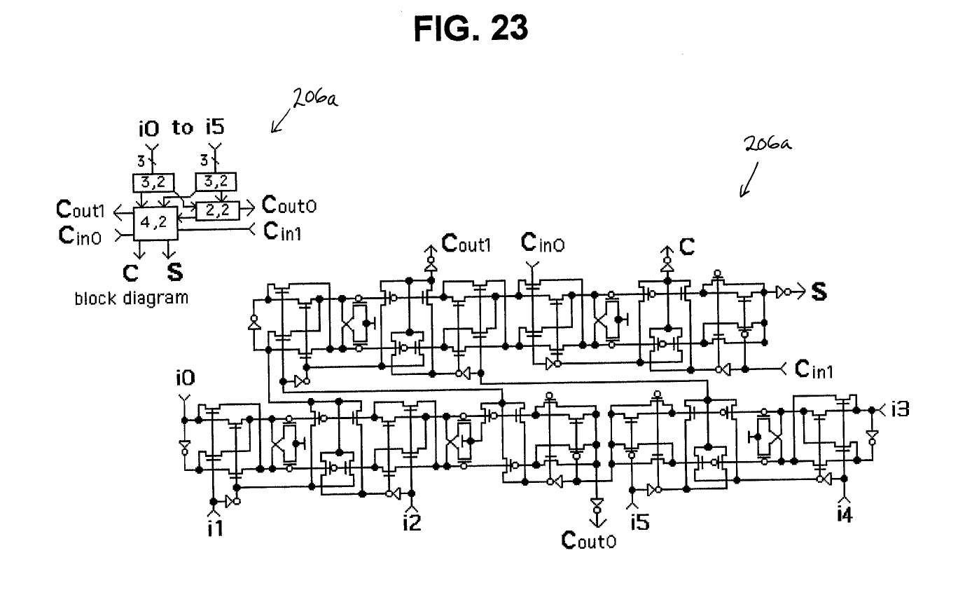

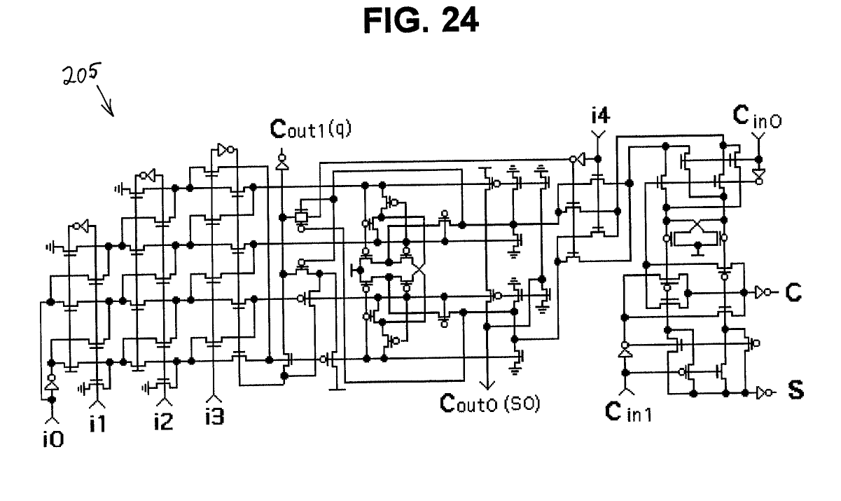

See FIG. 21. At the third stage, virtual multiplier 550 groups these 16×16-bit virtual multipliers 530 by fours into 4 identical arrays of 32×32-bit virtual multipliers 540, each adding up the 196 weighted partial product bits to produce 100 bits, using a shift switch parallel counter array with the core part consisting of 20 (5, 2) parallel counters 205, organized in the way similar to that shown in FIG. 20a (see FIGS. 26a, 26b and 26c for detailed cases). The output bit distribution is as follows: one bit each for columns 1 to 13 and 50 to 64, except 14, 54 and 58, two bit each for all other columns. See FIG. 22. At the fourth stage, virtual multiplier 550 groups these 32×32-bit virtual multipliers by fours into a single 64×64-bit parallel multiplier 550, which adds up the 400 weighted partial product bits to produce a total of 202 bits as two numbers, using a shift switch parallel counter array with the core part consisting of 38 (5, 2) parallel counters 205 (see FIG. 24), organized in the way similar to that shown in FIG. 20a (again, see FIGS. 26a, 26b and 26c for detailed cases). At the end, the two numbers generated by the virtual multiplier 550 are added by a carry-look-ahead adder (not shown), which is shorter than the similar final adders of existing designs, because the first about 20 columns already contain only one bit per column before the final addition.

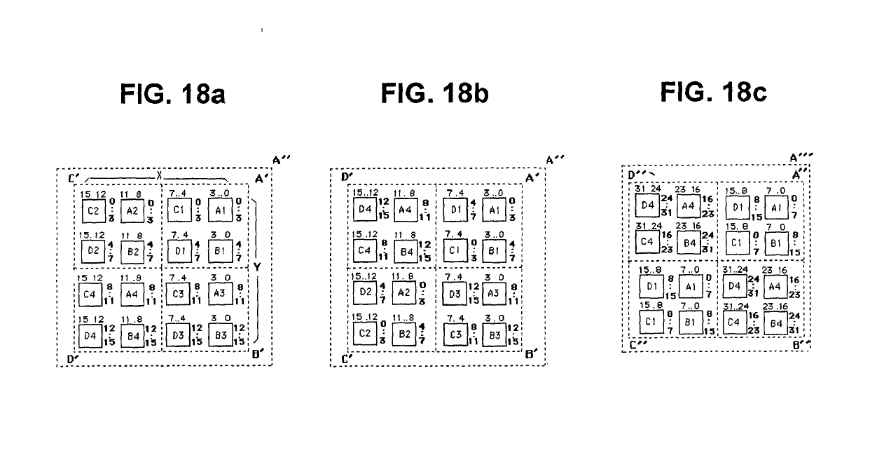

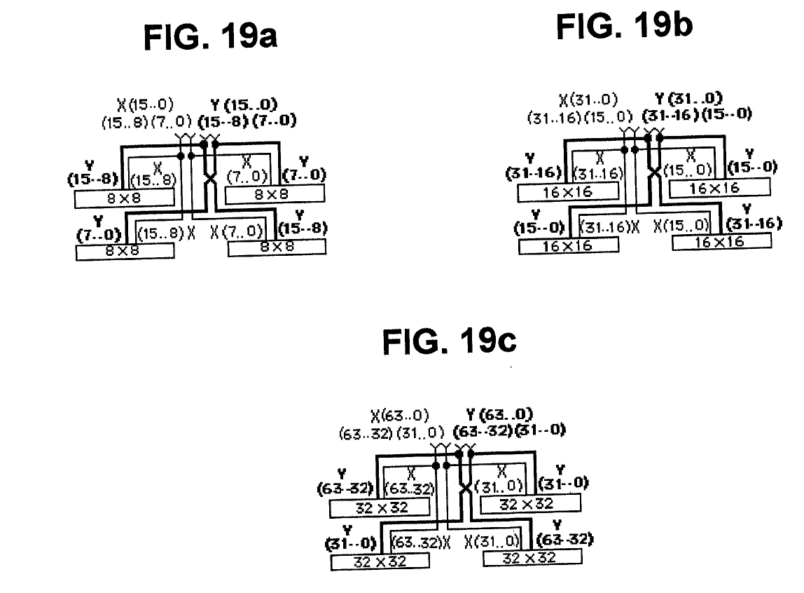

As can be seen from the form of the multiplier 550 in FIG. 25, all inter-stage connections, from 8×8-bit multipliers 520, up through 16×16-bit multipliers 530, 32×32-bit multipliers 540, and the final 64×64-bit multiplier 550, are simple, regular, and symmetrical. The longest wire connection in the final 64×64-bit virtual multiplier does not exceed that in traditional designs. Connection delays may also be minimized by the use of early signals and the optimized load/wire balance of the square structured network. In the square structured network each bit reduction module is associated with exactly one sub-tree of a full 4-branch input-bit tree (see FIGS. 19a, 19b, 19c, 18a, 18b, 18c) thus further simplifying the circuits.

Performance of Highly Regular Multiplier

SPICE simulations and preliminary layout tests of the multiplier component circuits have demonstrated the superiority of the invention's design. The delay and power comparisons are based on SPICE circuit simulation with a 0.25-micron process with a 2.5-V supply. The simulation has shown that a total multiplier delay of 4 ns can be achieved, before the final addition. The overall multiplier delay is expected to be comparable to the multiplier constructed by using the invention's first approach as described earlier. This is because it takes the advantage of followings: (1) There is no large 64×64 partial product matrix needed to generate; (2) The final addition adds two shorter numbers; (3) It is easy to produce a square structured layout.

This concludes the description of the invention's multiplier organization and behavior.

The Multiplier 's Circuit Architecture: Square Recursive Decomposition The invention uses a novel approach of decomposing a partial product matrix, called square recursive decomposition. This section describes the invention's family of square recursive decomposition designs for a new type of parallel multiplier.

In a first embodiment, in the lowest and simplest stage of the decomposition, FIG. 16a shows a 4×4 partial product matrix 510 generated by two 4-bit numbers X and Y on a network using a matrix of AND gates. The 4×4 multiplier 510 generates the product of X and Y by adding all weighted partial product bits s1+s2+s3+s4+s5+s6+s7+c (c for carry) of partial product matrix 505 along the diagonal direction shown in FIG. 16b. Each bit of the final sum is indicated by a small circle, and the carry bit c by a marked circle. The final sum s1+s2+s3+s4+s5+s6+s7, with its carry bit c, is the product of the two input 4-bit numbers.

In the next stage of the decomposition, the invention uses four such multipliers 510 to compute a product of two 8-bit numbers. FIGS. 16c and 16d show an 8×8 partial product matrix 520 which comprises four 4×4 multipliers, where the bit ranges from two 8-bit input numbers X and Y are duplicated as shown in FIG. 16c and sent to the component multipliers 510a, 510b, 510c, and 510d. (MSBs means most significant bits, LSBs means least significant bits.) The weighted bits of the four products of the four multipliers 510a, 510b, 510c, and 510d are added by two adders 622a and 622b to result in the final product of the 8×8 multiplier 520 (FIG. 16d).

The low-order four bits of the 16-bit final product are passed straight through from 4×4 multiplier 510a. The first adder 622a receives exactly three bits in each of its eight columns (along the diagonal direction) to produce the next eight bits of the product. The second adder 622b receives one bit per column and two carry-in bits from first adder 622a, to produce the top four bits of the product. The process is equivalent to the direct addition of partial products, therefore the result is the product of X and Y.

Repositioning Multipliers and Square Recursive Decomposition

FIGS. 16c, 16d, and 18a shows multiplier 510c and multiplier 510d, labeled C and D, in relative positions suggested by the organization of the partial product matrix. The invention improves on this relative positioning. In both stages of the decomposition described so far, the invention's parallel multiplier achieves significant performance, reliability and simplicity gains by exchanging the positions of two of the four component smaller multipliers. FIG. 18b show the same multipliers in the exchanged position used in the invention.

See FIGS. 18b and 18c, which illustrate two levels of nesting of multipliers. FIG. 18a shows the positions of all nested multipliers before exchanges are done in the design; FIGS. 18b and 18c show the positions of all nested multipliers after exchanges are applied in the design at the two levels shown. These exchanges are applied at all levels of the design. Referring back to FIG. 17, the diagonal summation connections travel directly from the B and C sub-multipliers to the adders, simplifying and shortening the connection traces in the more-complex part of the multiplier circuit.

In a second preferred embodiment, the invention uses a single 8×8 multiplier 520 (FIG. 17) at its lowest level of decomposition. The same rules of connection and composition apply as in the lowest-level 4×4 embodiment just described, but the connections are simpler and the circuit is faster. [Added to clarify lack of detailed circuit treatment for 4×4, now deleted from spec. I recommend we keep the 4×4 for clear conceptual illustration, even though it is not preferred and lacks circuits here. dwp]

With the described exchange modification, as shown in FIGS. 18b and 18c, the circuit diagram of a (virtual) 16×16 multiplier 530 becomes regular, symmetrical, and simple. The order of the four multipliers A′, B′ C′ and D′ shown in FIG. 20 is here called “square order.” The two multipliers providing the most-significant bits and the least-significant bits of the product, D′ and A′ respectively, are positioned farther from the final adder circuit than the two multipliers providing the central bits of the product. This relative positioning tends to balance the delays of the longer lines from D′ and A′ against the longer processing times required for summing the larger sets of bits in B′ and C′. The relative positioning also insures the shortest paths to the final adders for the most complex circuits. Most significantly, the exchange, or “flip” of the C′ and D′ multipliers reduces the trace crossings, a distinct advantage in circuits of the invention's level of complexity.

This repositioning is applied recursively at all levels of the decomposition. Continuing with the next level, in FIG. 18c the regular partial product matrix A′″, produced by two 32-bit numbers X (plain) and Y (bold), is decomposed into the two levels of square sub-matrices, 16×16 and 8×8, already described. In FIGS. 19c and 21 the sub-matrices are re-positioned suitable for constructions of four 16×16 multipliers 530, comprising one 32×32-bit multiplier 540, based on the square order approach.

For this 32×32-bit multiplier 540, the distribution of the input bits to the sub-matrices of the decomposed partial product matrix takes the form of a full 4-branch tree of 2 levels.

Subsequent stages of composition, producing finally a 64×64-bit multiplier 550, again apply the repositioning. See FIG. 22 for details of the 64×64-bit multiplier 550.

For a top-down view of the decomposition, refer first to FIG. 19c. For the 64×64-bit multiplier 550, the distribution of the input bits to the sub-matrices takes the form of a full 4-branch tree for two 64-bit inputs X and Y. Each branch of this tree is a 32×32-bit multiplier 540 shown in FIG. 19b. This nesting of multipliers continues through 3 levels, as shown in FIGS. 19c, 19b, and 19a, down to where the constituent multipliers 520 are 8×8-bit in size.

This application of recursive decomposition and repositioning of multipliers produces better load/wire balance than the known traditional approaches to multiplier circuits.

Multiplier Architecture Summary

Based on the above description of the decomposition and repositioning of multiplier components, the multiplier comprises the following components:

1. Partial product generation networks, starting at the level of 8×8-bit arithmetic. Instead of using a single large bit matrix (64×64-bit, or about a half of that size when Booth recoding is applied) commonly adopted by the traditional designs, the invention incorporates 64 small identical 8×8-bit partial product matrices in the repositioned form described in the previous section.

2. 64 identical 8×8-bit virtual multipliers 520, each producing 26-bit partial products.

3. 16 identical 16×16 virtual multipliers 530, each producing 49-bit partial products.

4. 4 identical 32×32 virtual multipliers 540, each producing 100-bit partial products.

5. One virtual multipliers 550 producing 2 final numbers for the final addition.

A simpler carry look-ahead final adder adding two 108 bit numbers (not shown here). This concludes the description of the invention's multiplier circuit architecture.

Multiplier Performance and Configuration

Based on SPICE simulations, the shift switch logic counter's VLSI area (in terms of transistor counts), speed and power compare favorably to conventional designs, such as (3,2)- and/or (4, 2)-based schemes. The 8×8 virtual multiplier is implemented based on the low-power, high speed shift switch (6, 2) parallel counter 206 already described. All counter arrays in FIGS. 20, 21, and 22 are implemented based on the (5, 2) parallel counter 205 (FIG. 24) and the (2, 2), (3, 2), and (4, 2) parallel counters 202, 203 and 204 (FIGS. 9, 9a, 9b, and 10). The critical path for each of the stages 2, 3 and 4 has a delay totally determined by the (5, 2) counter 205. The (5, 2) counter 205 is, in fact, a (6, 2) counter 206 except that it contains one shift BAR fewer, and has a smaller delay (less than ins). The formula for the (5, 2) counter: i0+i1+i2+i3+2*i4+2*Cin0+2*Cin1=Cout0+4*Cout1+2*S+4*C.

This concludes the description of the invention's adder circuit implementations for its parallel multiplier.

Parallel Multiplier Summary

The novel, low-power, highly regular design of the invention's parallel multiplier has significantly expanded and improved the design and implementation choices for large arithmetic units. This improvement is achieved through the use of large numbers of identical low-power, high-performance 4-bit state-signal-based shift switch components, the (6, 2) counter-based 8×8 virtual multipliers and (5, 2) counter-based counter arrays, and through the use of repeatable modules (sub-multipliers). The invention's parallel multiplier design has minimized the common irregularity occurred in existing designs and simplified the overall logic design and wiring structures. SPICE circuit simulations have demonstrated the superiorities of the new component circuits and the critical paths of the multiplier design, showing a significant reduction in power dissipation compared with recently reported counterparts while achieving high speed and small VLSI area.

This concludes the description of the second major feature of the present invention: its low power highly regular parallel multiplier design.

A Novel Reconfigurable Matrix Multiplier Architecture

The third major feature of the invention is a novel, reconfigurable, high-performance matrix multiplier architecture and its component circuits. To clarify, the term “matrix” as used in this section refers not to the partial product matrix of a multiplier, but instead to a mathematical matrix requiring multiplication by a number or by another mathematical matrix.

Ordinary number multiplication is one of the most computationally-demanding arithmetic operations that can be performed on a computer. Matrix multiplication requires many such multiplications, and is therefore a critical problem in computer calculation. For example, to multiply two matrices Xₙₖ and Yₖₘ, where X is a matrix with n rows and k columns, and Y is a matrix with k rows and m columns, requires n×k×m multiplications of varying precision. Many standard texts on matrix multiplication explain the mathematical details.

Most conventional computer arithmetic circuits perform the individual numeric multiplications needed for a single matrix product in serial fashion. Other conventional circuits are designed and built to process several multiplications in parallel, but such designs require expensive space on silicon, and are not adaptable to different types of matrices. A major advantage of the invention's matrix multiplier is that it can be easily reconfigured at the time of operation to compute efficiently the product of mathematical matrices Xₙₖ and Yₖₘ for any integers n, k, m and any item precision b (ranging from 4 to 64 bits) with maximum utilization of the hardware available. In effect, the same set of multiplier-circuit elements may be dynamically reassigned to different roles during the multiplication of two matrices. The invention resolves the multiplier design conflict between versatility and computation speed, providing a feasible and efficient processor in terms of speed, VLSI area, and particularly, power dissipation, for many scientific and engineering applications.

The invention allows the major hardware equivalent to a couple of 64×64-bit high precision multipliers in the system to be directly reconfigured to calculate the product of two matrices both of which may take several different input forms. For example, it can form the product of X_{4×4} and Y_{4×4} of 16-bit items in 6 pipeline cycles, the product of X_{8×8} and Y_{8×8} of 8-bit items in 9 pipeline cycles, or the product of X_{16×16} and Y_{16×16} of 4-bit items in 16 pipeline cycles. In a non-reconfigurable high precision system not utilizing the invention, these matrix multiplications would require respectively 2⁶, 2^{9,} and 2¹² multiplications, each one performed by a large hardware multiplier regardless of its precision requirement.

The invention's matrix multiplier can be efficiently reconfigured for directly computing a product matrix using an input stream of h×h matrix pairs with b-bit matrix elements. Given two such square matrices X_{h×h} and Y_{h×h}, and a small multiplier capable of multiplying two m×m-bit numbers, the invention's matrix multiplier of size s=hb receives a column from X and a row from Y in each step, and produces the product of XY in a total of h+log(b/m) steps or about one product per h pipeline steps.

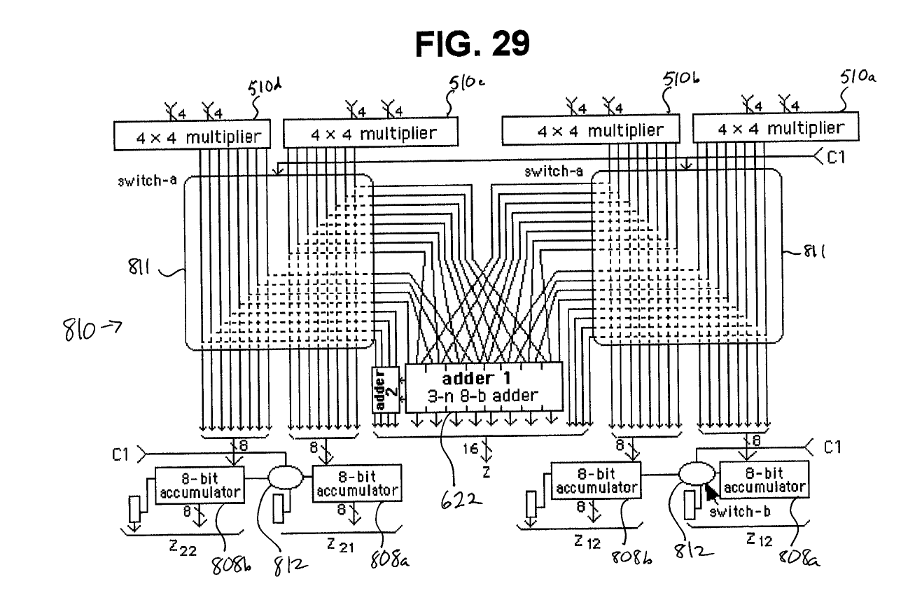

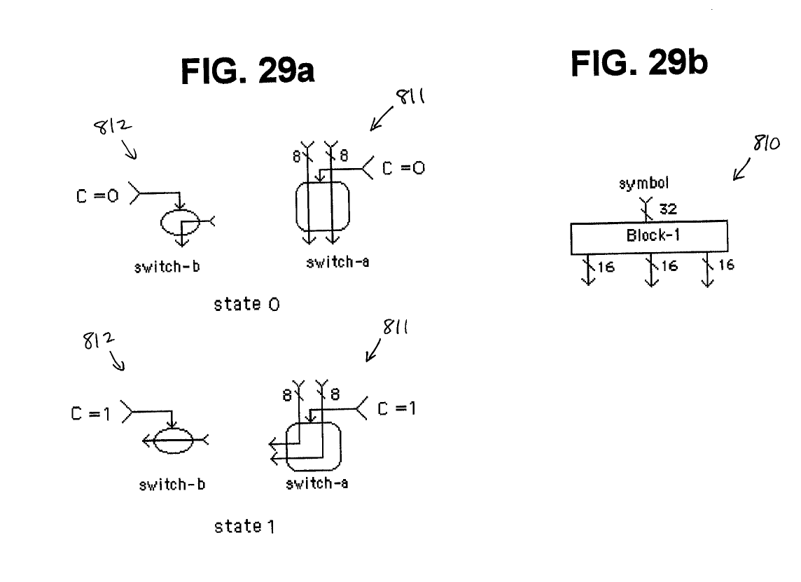

In a preferred embodiment, the invention's matrix multiplier of size s comprises an array, of size equal to (s/m)², of m×m small multipliers; a few arrays of adders each adding three numbers; and an array of accumulators and corresponding simple reconfiguration switches. Such processors with rather small s and m=4 are shown in FIGS. 29, 29a, and 29b. Because of high modularity and regularity of our approach, a matrix multiplier embodiment of large size, say (s,m) =(128, 8), which computes the product of Xₕₓₕ and Yₕₓₕ of b-bit items for (h, b)=(32, 4), (16, 8), (8, 16), (4, 32) or (2, 64) in about h pipeline cycles, is useful for general applications, given current VLSI technology.

To achieve its best performance in matrix multiplication, the invention applies the familiar technique of matrix partitioning. To compute the product of Xₙₖ and Yₖₘ of item precision b on the proposed processor of size s, a user partitions Xₙₖ and Yₖₘ into s/b×s/b sub-matrices, and supplies signals to the invention which indicate how the multiplier's components should be configured to process the sub-matrices effectively. The invention reconfigures the processor according to the values of s (fixed) and b (input parameter), computes the products of the partitioned sub-matrices, and accumulates them to produce the final result in pipelined fashion. As described in the preceding sections of this specification, the invention utilizes a unique recursive decomposition of a partial product matrix, repeated use of low-power high-performance small m×m (m=4 or 8) multipliers, and small adder circuit blocks based on the invention's shift switch logic.

For a desired computation, the invention reconfigures the multiplier dynamically, using between one and 2 control bits supplied by the supporting arithmetic circuit. The hardware required by the invention's matrix multiplier to handle 5 cases of input structures, i.e., for (h, b) =(32, 4), (16, 8), (8, 16), (4, 32) or (2, 64), is about twice the hardware that is required by a non-reconfigurable multiplier capable of handling only one of the cases.

The invention's novel approach of decomposing a partial product matrix, called square recursive decomposition, was described in the previous section. This section describes the embodiments of the invention which implement the invention's reconfigurable parallel matrix multipliers.

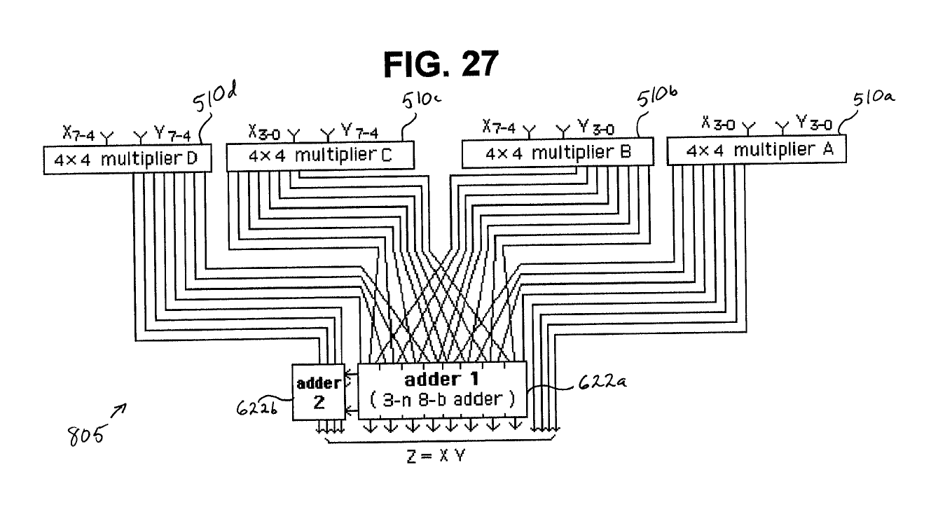

The reconfigurable multiplier operates on ordinary numeric values as described in the previous section. FIG. 27 illustrates the structure's circuit architecture 805 for a simple multiplication. To review the process, FIG. 16a shows a 4×4 partial product matrix 505 generated by two 4-bit numbers X and Y on a network with a matrix of AND gates. The product of X and Y is generated by adding all weighted partial product bits along the diagonal directions. Refer to FIG. 16b. Each bit of the final sum (s1 s2 s3 s4 s5 s6 s7 c), or the product, is then indicated by a small circle, and the carry bit by a marked circle. FIG. 16c and FIG. 16d show an 8×8 partial product matrix which is decomposed into four 4×4 matrices, where the data from two input numbers X and Y are duplicated and sent to the decomposed multipliers 510a, 510b, 510c, and 510d. The weighted bits of the four products of the four multipliers are added by two adders 622a and 622b to generate the final product of the 8×8 multiplier (FIG. 16d). The first adder 622a (at right bottom) receives exactly three bits in each of its eight columns (along the diagonal direction), the second adder 622b (at left bottom) receives one bit per column and two carry-in bits from the first adder. Clearly the process is equivalent to the direct addition of partial products, therefore the result is the product of X and Y.

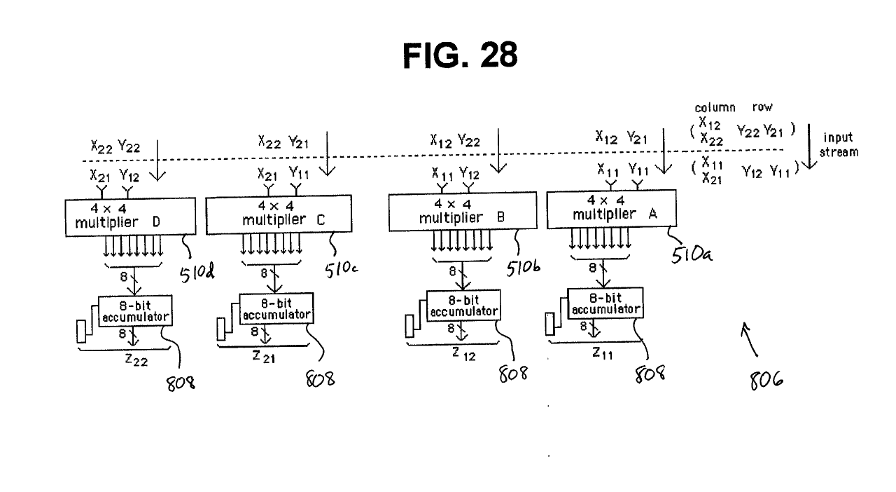

Refer to FIG. 28. The required pipelined circuit architecture 806 with multipliers 510a, 510b, 510c, 510d and accumulators 808 for the computation is shown where the inputs are two matrices X_{2×2}, Y_{2×2} comprising a total of 16 4-bit elements. The desired computation is the matrix multiplication product Z=XY.

Refer now to FIG. 29. The invention combines these two structures 805 and 806 into a single reconfigurable matrix multiplier 810 by adding two 1-bit-controlled switches 811 and two 1-bit-controlled switches 812 (see FIG. 29a). Switches 811 route all 4×4 multiplier outputs either to a 3-number 8-bit adder 622 as shown in FIG. 27, or to separate 8-bit accumulators 808a, 808b as shown in FIG. 28. As shown in FIG. 29, the invention generates the product of two 8-bit numbers by setting switches 811 and 812 (C1) to 1, and generates the product of two matrices X_{2×2} and Y_{2×2} of 4-bit items by setting switches 811 and 812 (C1) to 0. With switches 811 set to 1, the outputs of multipliers 510 are routed to 3-n 8-b adder 622; with switches 811 set to 0, the outputs of multipliers 510 are routed to four separate accumulators 808a, 808b.

Recursive Expansion of the Reconfigurable Multiplier

The invention's reconfigurable matrix multiplier, as described above for decomposition of an 8×8 partial product matrix into four 4×4 partial product matrices, is expanded recursively for larger-size inputs to such computations.

Note that reconfigurable multiplier 810 (excluding the accumulators) is represented in later figures by the symbol in FIG. 29b.

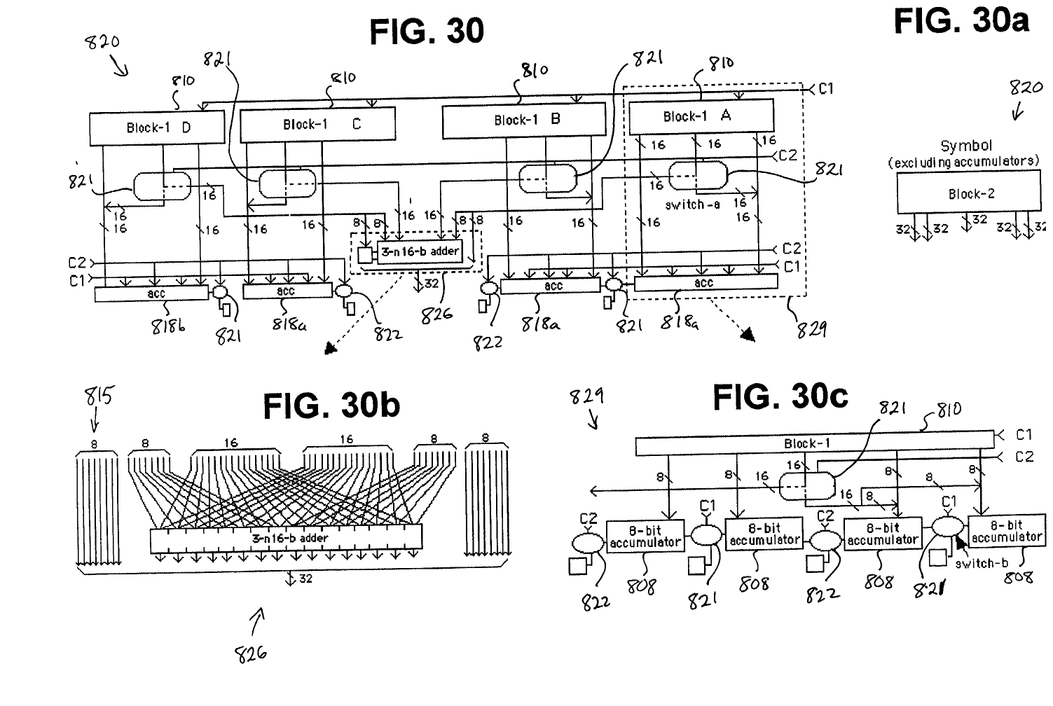

Refer to FIG. 30. The invention's reconfigurable matrix multiplier design is extended at this stage to construct a multiplier 820 with (s, m)=(16, 4). Four 3-n 16-bit adders 826, corresponding large accumulators 818a, 818b, and additional switches 821, 822 (controlled by bit C2) are sufficient. FIG. 30c shows the detail 829 of one quarter of multiplier 820, showing that large accumulator 818a or 818b is comprised of four 8-bit accumulators 808, two switches 821 controlled by C1, and two switches 822 controlled by C2.

When both C1 and C2 are set to 1, multiplier 820 generates the product of two numbers of 16 bits. The routing of bits for this case is shown in FIG. 29b. When C1=1 and C2=0, multiplier 820 generates the product of two matrices X_{2×2} and Y_{2×2} of 8-bit items; and when both C1 and C2 are set to 0, it generates the product of two matrices X_{4×4} and Y_{4×4} of 4-bit items. The following shows an example of switch setting. Refer to FIGS. 29, 29a, 30 and 30c. When C1 is 1 and C2 is 0, switches 811 and the switches 812 are both set to state 1, while switches 821 is set to state 0. This setting routes both the 3-number 8-bit adder output to the first two 8-bit accumulators 808a and 808b, and the carry bit of low-order accumulators 808a to high-order accumulators 808b.

Note that reconfigurable multiplier 820 is represented in later figures by the symbol in FIG. 30a.

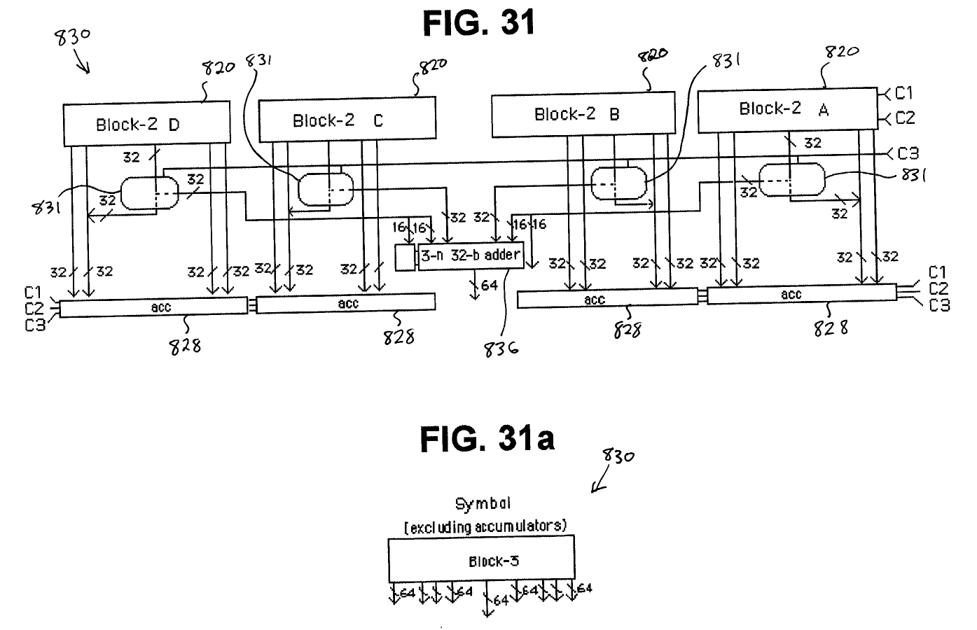

The next level of the invention's reconfigurable matrix multiplier 830 is shown in FIG. 31. A new layer of switches 831 (C3) has been added for alternate routing of products; large accumulators 828 are constructed as doublings of large accumulators 818a, 818b; and for the largest ordinary two-number products, the 3-n 32-b adder 836 is incorporated.

Note that reconfigurable multiplier 830 is represented in later figures by the symbol in FIG. 31a.

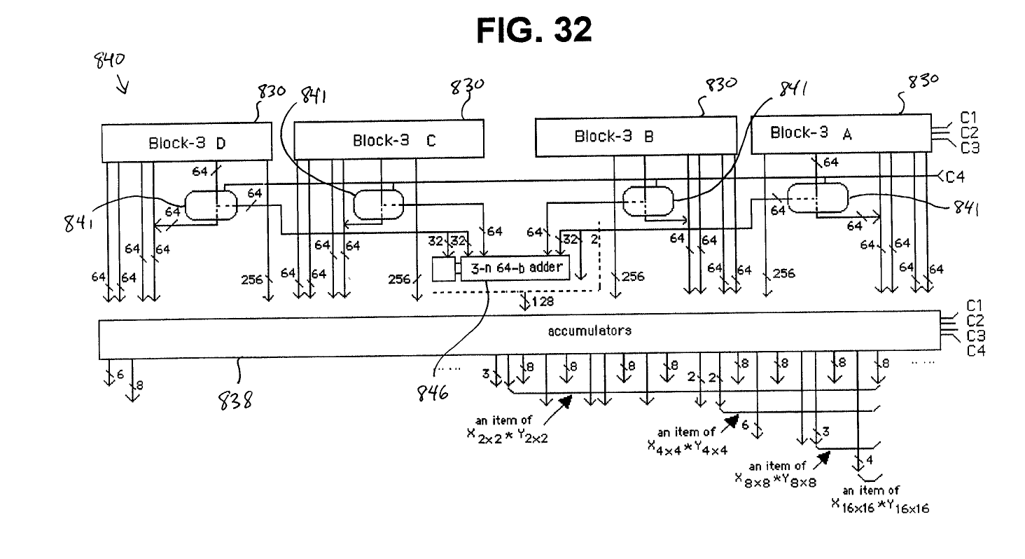

The final extension of the invention's reconfigurable matrix multiplier 840 is shown in FIG. 32. A new layer of switches 841 (C4) has been added for alternate routing of products; large accumulators 838 are constructed as doublings of large accumulators 828; and for the largest ordinary two-number products, the 3-n 64-b adder 846 is incorporated. Multiplier 840 generates the product of X_{16×16} and Y_{16×16} of 4-bit items in 16 pipeline cycles; the product of X_{8×8} and Y_{8×8} of 8-bit items in 9 cycles, the product of X_{4×4} and Y_{4×4} of 16-bit items in 6 cycles, the product of X_{2×2} and Y_{2×2} of 32-bit items in 5 cycles, and the product of two numbers of 64-bit in 5 cycles.

Embodiments of the invention's reconfigurable matrix multiplier with m=8 and larger size are constructed in a manner analogous to the method just described.

Input Distribution Networks

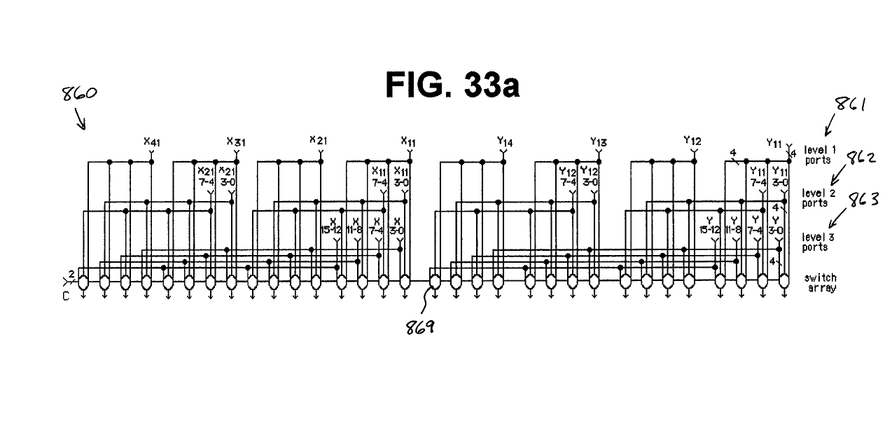

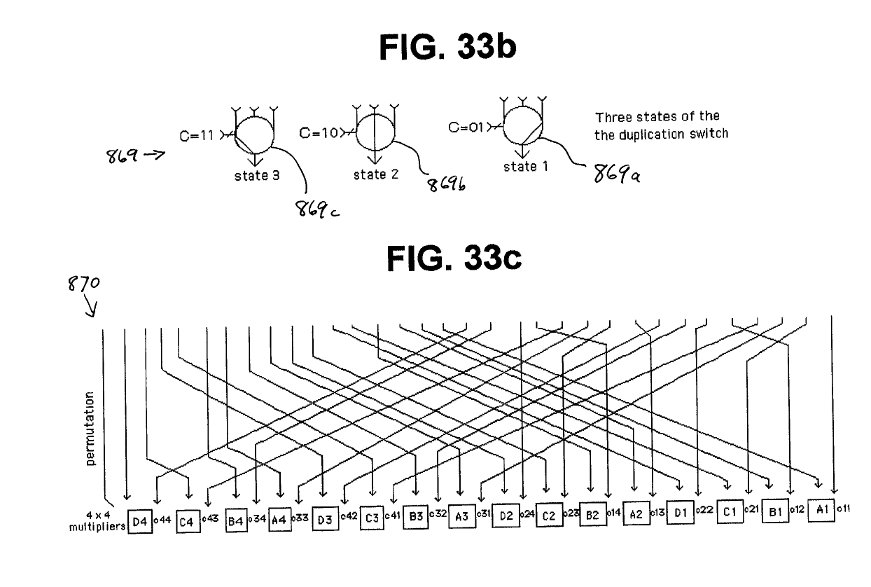

To duplicate and distribute the input data stream to the reconfigurable matrix multiplier, the invention incorporates two additional simple networks: a reconfigurable network 860 and a fixed data permutation (routing) network 870. FIG. 33a shows reconfigurable network 860 for the matrix multiplier with (s, m)=(16, 4). FIG. 33c shows data permutation network 870 for the same matrix multiplier. FIG. 33b shows a duplication switch element 869 which controls each bit path between the two networks. Three states of duplication switch element 869 are shown: state 1 869a for C=01, state 2 869b for C=10, and state 3 869c for C=11.

In FIG. 33a, the reconfigurable network features three separate sets of input ports 861, 862, 863 for the inputs to be multiplied and the switch states. Depending on the configuration of inputs, the input signals are duplicated in different patterns for the multiplier by setting switches to corresponding states. The duplicated data are routed to the 4×4 multipliers by fixed wiring connection network 870 shown in FIG. 33c.

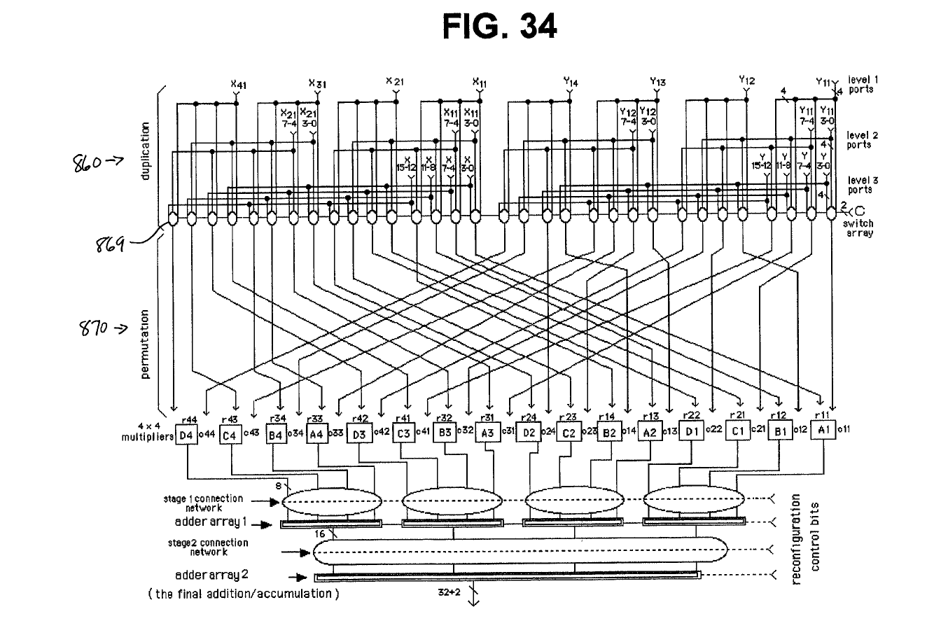

FIG. 34 shows the complete ensemble of reconfigurable network 860 and fixed data permutation (routing) network 870 shown separately in FIGS. 33a and 33c. FIG. 34 also shows the connection of these input networks to the adders used in the next stage of multiplication.

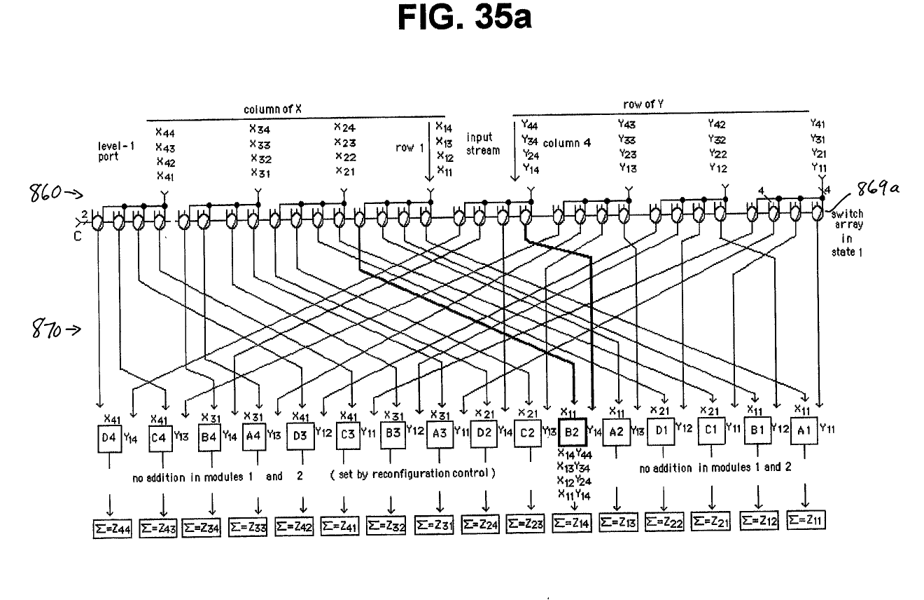

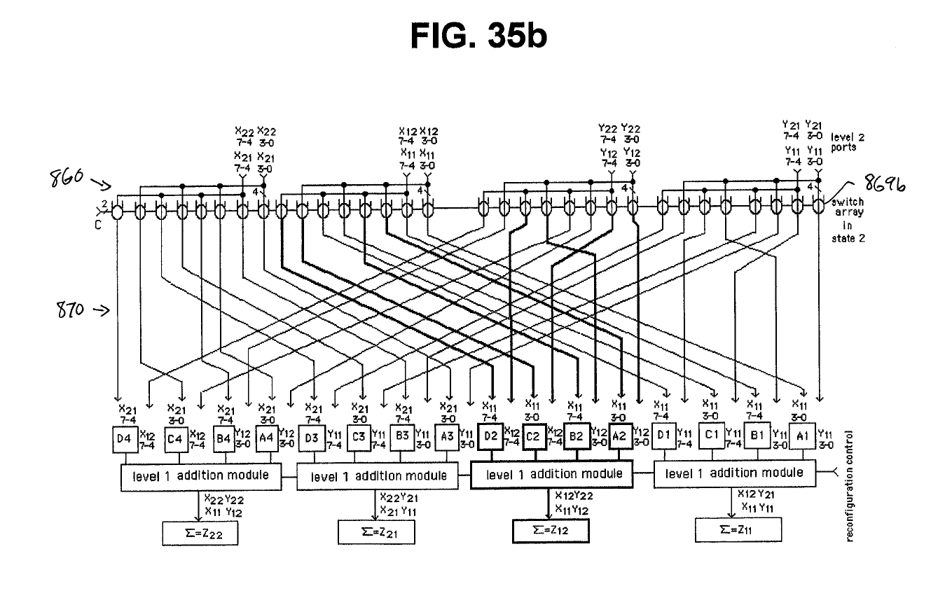

Refer to FIG. 35a, which shows the input networks 860, 870 for the invention's reconfigurable matrix multiplier 820 with (s, m)=(16, 4). In this figure the duplication switch element 869 (FIG. 33b) is shown in state 1 869a. The resulting input stream, data distribution, and pipeline data flow of a column from X_{4×4} and a row from Y_{4×4,} each with 4-bit items, are shown. Note the bold lines, indicating that data are pipelined to 4×4-bit multiplier B2. Matrix element products X₁₁ Y₁₄, X₁₂ Y₂₄, X₁₃ Y₃₄, and X₁₄ Y₄₄ are accumulated to a single matrix multiplication product result Z₁₄.

Refer to FIG. 35b, which shows the same input networks 860. In this figure the duplication switch element 869 is shown in state 2 869b. The resulting input stream, data distribution, and pipeline data flow of a column from X_{2×2} and a row from Y_{2×2,} each with 4-bit items, are shown. Note the bold lines, indicating that data are pipelined to four 4×4-bit multiplier A2, B2, C2, D2. Matrix element products X₁₁ Y₁₂ and X₁₂ Y₂₂ are accumulated to a single matrix multiplication product result Z₁₂.

Finally, if the switch element 869 is set to state 3, the multiplier 820 generates the product of two numbers of 16 bits each.

For an input stream (column-row pair) of 2×2 matrices of 8-bit items, the level-2 ports (instead of level 1 ports) are used and C is set to state 2; for input of two 16-bit numbers the level-3 ports are used and C is set to state 3. Using the two input networks, the matrix multiplier performs varied matrix product computations efficiently; for two given matrices X_{h×h and Y}_{h×h} of b-bit items, the matrix multiplier of size s=hb receives a column from X and a row from Y in each pipeline step, and generates the product of X and Y in a total of h+log(b/m) steps (or about one product per h pipeline steps).

If input matrices Xₙₖ and Yₖₘ are partitioned into (s/b)×(s/b) sub-matrices, the invention's reconfigurable matrix multiplier of fixed size s facilitates their pipelined computation for any integers n, k, m and item precision b. Item precision b may vary from 4 bits to 64 bits.

Matrix Partitioning Examples

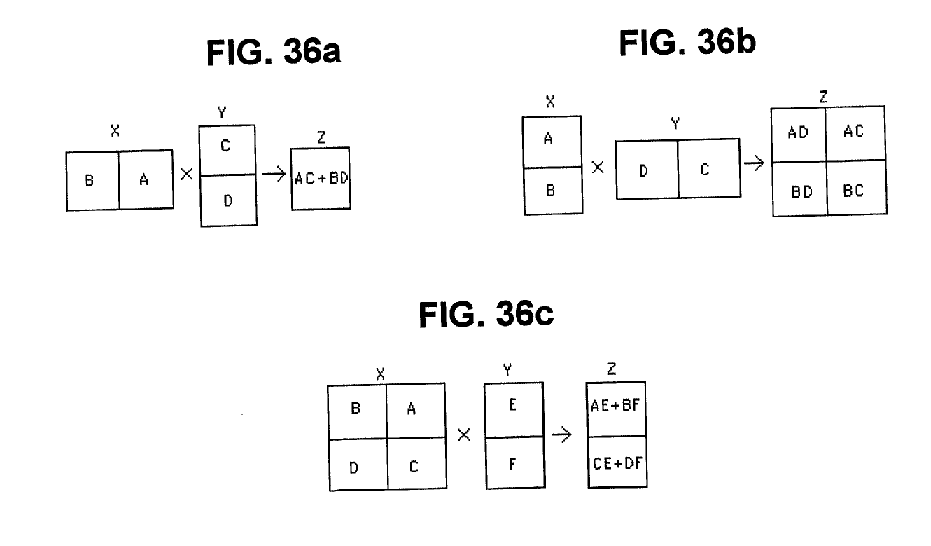

Simple examples of matrix partitioning are shown in FIGS. 36a, 36b, and 36c. Each of A, B, C, and D in each figure represents a sub-matrix of an overall matrix X, Y or Z represented by joined boxes. In FIG. 36a, X_{1×2}×Y_{2×1}=Z_{1×1}; to compute Z requires computing (A×C)+(B×D) to produce a single sub-matrix which is itself Z. In FIG. 36b, X_{2×1}×Y_{1×2}=Z_{2×2}; to compute Z requires computing A×D, A×C, B×D and B×C to produce the four sub-matrices comprising the elements of Z. In FIG. 36c, X_{2×2}×Y_{2×1}=Z_{2×1}; to compute Z requires computing (A×E)+(B×F) and (C×E)+(D×F) to produce the two sub-matrices comprising the elements of Z. In each case, given the constraints imposed by item precision, the invention computes the necessary products within A, B, C and D in parallel. Assuming the matrix multiplier available is of size s, each square shows an s/b×s/b sub-matrix, where b is the item precision in bits.

Many matrix multiplication tasks involve matrices with substantial proportions of zero or small-integer elements. In such cases, the advantages of the invention's matrix-multiplication parallelism can be most fully realized.

This concludes the description of the third major feature of the invention: its novel reconfigurable high-performance matrix multiplier architecture and component circuits.

Conclusion, Ramifications, and Scope of Invention

The invention's shift-switch-based partial product matrix reduction circuit supports rapid and compact multiplication of two 64-bit numbers or two 64-bit floating point numbers with 53-bit mantissas. The performance and size benefits of this matrix reduction circuit amplify the value of the invention's remaining major features. The invention's novel low-power, highly regular parallel multiplier design has significantly improved the design and implementation choices for large arithmetic units. This improvement is achieved through the use of large amount of identical low power, high performance 4-bit state signal based shift switch components (4×4 virtual multipliers and small 3-n adders), and using repeatable modules (sub-multipliers). The invention's parallel multiplier design has minimized the common irregularity occurred in existing designs and simplified the overall logic design and wiring structures.

The invention's reconfigurable, high-performance matrix multiplier design can be efficiently reconfigured to compute the product of matrices Xₙₖ and Yₖᵣ, for any integers n, k, m and any item precision b (ranging from 4 to 64 bits) thus maximizing the utilization of the hardware available. The proposed approach has significantly improved quality for the large arithmetic unit design. The superiority of the design is also achieved through the use of a large proportion of identical low-power, high-performance 4-bit state signal based shift switch logic components for small adder blocks (typically adding 3 8-bit numbers), 4×4 multipliers, and accumulators, and through the use of modules (sub-multipliers) and repeatable parts. The invention's design has minimized the common irregularity that occurs in conventional designs, and has simplified the overall logic design and wiring structures.

SPICE circuit simulations with 0.25 Micron, 2.5 V supply process on the new components and the critical paths of the circuits have demonstrated the invention's advantages at every level, showing a large reduction in power dissipation compared with recently reported counterparts while achieving high speed and small VLSI area.

The invention offers a fast, powerful, compact, flexible, and efficient CMOS VLSI parallel multiplier design, realized in multiple circuit embodiments in order to address a wide range of system requirements. From the above descriptions, figures and narratives, the invention's advantages should be clear.

Although the description, operation and illustrative material above contain many specificities, these specificities should not be construed as limiting the scope of the invention but as merely providing illustrations and examples of some of the preferred embodiments of this invention.

Thus the scope of the invention should be determined by the appended claims and their legal equivalents, rather than by the examples given above.

1. A shift bar circuit for receiving one or more independent binary input signals and converting said binary signals into a state signal having one unique bit and representative of the input binary signals.

2. The shift bar circuit of claim 1 further comprising a restoration circuit connected to the state signal for restoring the state signal to a desired voltage level.

3. The shift bar circuit of claim 1 further comprising a carry circuit coupled to the outputs of each shift bar circuit for generating an output corresponding to carry bits generated by the shift bar circuit.

4. The shift bar circuit of claim 1 further comprising a second or more shift bar circuits cascaded together to produce a modulo sum and one or more carry bits;
an encoder circuit for converting the shift level modulo sum signal into a binary sum output signal.

5. The shift bar circuit of claim 4 further comprising a full adder coupled to the output the encoder circuit.

6. A shift switch parallel counter having one bar circuit for receiving one binary input signal of weight 1 and one shift bar binary input signal of weight 1, and producing a binary sum bit of weight 1 and a binary carry bit of weight 2.

7. The shift switch parallel counter circuit of claim 6 comprising a shift switch parallel counter compressing two inputs bits into two output bits.

8. The shift switch parallel counter circuit of claim 6 receiving one binary input signal of weight 1 and further comprising a second shift bar binary input signals of weight 1, and producing a binary sum bit of weight 1 and a binary carry bit of weight 2.

9. The shift switch parallel counter circuit of claim 8 comprising a shift switch parallel counter compressing three inputs bits into two output bits.

10. The shift switch parallel counter circuit of claim 8 receiving one binary input signal of weight 1, three shift bar binary input signals of weight 1, and a binary input carry signal of weight 1, and producing a binary sum bit, a binary carry bit of weight 2, and one binary output signal of weight 2 corresponding to an in-stage carry bit generated by the shift bar circuits.

11. The shift switch parallel counter circuit of claim 10 comprising a shift switch parallel counter compressing four inputs bits into two output bits.

12. A compressor circuit comprising:
two or more shift bar circuits cascaded with each other,
a restoration circuit coupled to the output of the last shift bar circuit;
a carry circuit coupled to the shift bar circuits;
an encoder circuit coupled to the output of the last shift bar circuit; wherein
each shift bar circuit having a plurality of state signal lines and a binary input signal connected to all of the state signal lines for shifting the state signals in accordance with the value of the shift bar input binary signal to create a modulo sum and carry bits in accordance with the combination of the independent input binary signals and the bar circuit input binary signals,
the state signal lines of one of the shift bar circuits coupled to the output of the input converter circuit for receiving the first state signal,
said restoration circuit coupled to the output of the last shift bar circuit for restoring the signal level of the state signals to their input levels,
said carry circuit coupled to the outputs of each shift bar circuit for generating an output corresponding to carry bits generated by the shift bar circuits,
said encoder circuit for converting the shift level modulo sum signal into a binary sum output signal.

13. A compressor circuit comprising:
an input converter circuit,
two or more shift bar circuits cascaded with each other,
a restoration circuit,
a carry circuit, and
an encoder circuit,
said input converter circuit for receiving one or more independent binary input signals, converting said binary signals into a first state signal having one unique bit and representative of the input binary signals,
each shift bar circuit having a plurality of state signal lines and a binary input signal connected to all of the state signal lines for shifting the state signals in accordance with the value of the shift bar input binary signal to create a modulo sum and carry bits in accordance with the combination of the independent input binary signals and the bar circuit input binary signals,
the state signal lines of one of the shift bar circuits coupled to the output of the input converter circuit for receiving the first state signal,
said restoration circuit coupled to the output of the last shift bar circuits for restoring the signal level of the state signals to their input levels,
said carry circuit coupled to the outputs of each shift bar circuit for generating an output corresponding to carry bits generated by the shift bar circuits,
said encoder circuit for converting the shift level modulo sum signal into a binary sum output signal.

14. A shift switch parallel counter circuit for counting binary input signals and producing a sum signal and a plurality of carry signals, comprising:
an input converter circuit,
two or more shift bar circuits cascaded with each other,
a restoration circuit,
a carry circuit,
an encoder circuit, and
a full adder circuit,
said input converter circuit for receiving one or more independent binary input signals, converting said binary signals into a first state signal having one unique bit and representative of the input binary signals,
each shift bar circuit having a plurality of state signal lines and a binary input signal connected to all of the state signal lines for shifting the state signals in accordance with the value of the shift bar input binary signal to create a modulo sum and carry bits in accordance with the combination of the independent input binary signals and the bar circuit input binary signals,
the state signal lines of one of the shift bar circuits coupled to the output of the input converter circuit for receiving the first state signal,
said restoration circuit coupled to the output of the last shift bar circuits for restoring the signal level of the state signals to their input levels,
said carry circuit coupled to the outputs of each shift bar circuit for generating an output corresponding to carry bits generated by the shift bar circuits,
said encoder circuit for converting the shift level modulo sum signal into a binary sum output signal,
said full adder circuit for adding one or more late-arriving binary signals to the binary sum output signal to produce a binary sum bit and a binary carry bit.

15. The shift switch parallel counter circuit of claim 14 receiving four binary input signals of weight 1, one shift bar binary input signal of weight 2, and two binary input carry signals of weight 2, and producing a binary sum bit of weight 2, a binary carry bit of weight 4, and two binary output signals of weight 1 and weight 4 respectively corresponding to in-stage carry bits generated by the shift bar circuits.

16. The shift switch parallel counter circuit of claim 15 comprising a shift switch parallel counter compressing five inputs bits into two output bits.

17. The shift switch parallel counter circuit of claim 14 receiving three binary input signals of weight 1, two shift bar binary input signal of weight 1, one shift bar binary input signal of weight 2, and two binary input carry signals of weight 2, and producing a binary sum bit of weight 2, a binary carry bit of weight 4, and two binary output signals of weight 1 and 4 respectively corresponding to in-stage carry bits generated by the shift bar circuits.

18. The shift switch parallel counter circuit of claim 17 comprising a shift switch parallel counter compressing six inputs bits into two output bits.

19. The shift switch parallel counter circuit of claim 14 receiving five binary input signals of weight 1, two shift bar binary input signals of weight 1, and two binary input carry signals of weight 2, and producing a binary sum bit of weight 2, a binary carry bit of weight 4, and two binary output signals of weights 1 and 4 respectively corresponding to in-stage carry bits generated by the shift bar circuits.

20. The shift switch parallel counter circuit of claim 19 comprising a shift switch parallel counter compressing six inputs bits into two output bits and a shift switch parallel counter compressing three input bits into two output bits.

21. The shift switch parallel counter circuit of claim 14 receiving five binary input signals of weight 1, three shift bar binary input signals of weight 1, and two binary input carry signals of weight 2, and producing a binary sum bit of weight 2, a binary carry bit of weight 4, and two binary output signals of weight 1 and two binary output signals of weight 4 corresponding to in-stage carry bits generated by the shift bar circuits.

22. The shift switch parallel counter circuit of claim 21 comprising a shift switch parallel counter compressing six inputs bits into two output bits and two shift switch parallel counters each compressing three input bits into two output bits.

23. The shift switch parallel counter circuit of claim 14 receiving five binary input signals of weight 1, four shift bar binary input signals of weight 1, one binary input carry signal of weight 1, and two binary input carry signals of weight 2, and producing a binary sum bit of weight 2, a binary carry bit of weight 4, and two binary output signals of weight 1, one binary output signal of weight 2, and two binary output signals of weight 4 corresponding to in-stage carry bits generated by the shift bar circuits.

24. The shift switch parallel counter circuit of claim 23 comprising a shift switch parallel counter compressing six inputs bits into two output bits, a shift switch parallel counter compressing four input bits into two output bits, and a shift switch parallel counter compressing three input bits into two output bits.

25. The shift switch parallel counter circuit of claim 14 receiving three binary input signals of weight 1, one shift bar binary input signal of weight 1, one shift bar binary input signal of weight 2, and two binary input carry signals of weight 2, and producing a binary sum bit, a binary carry bit, and two binary output signals of weight ?? and ?? respectively corresponding to in-stage carry bits generated by the shift bar circuits.

26. The shift switch parallel counter circuit of claim 25 comprising a shift switch parallel counter compressing six inputs bits into two output bits.

27. A partial product matrix reduction circuit comprising:
two or more stages of parallel counters, each stage reducing a number of input bits into a smaller number of output bits and the last stage reducing the number of its input bits to two output bits.

28. The partial product matrix reduction circuit of claim 27 wherein the parallel counters comprise interconnected cascaded shift switch parallel counter circuits, each shift switch parallel counter circuit comprising:
an input converter circuit,
two or more shift bar circuits cascaded with each other,
a restoration circuit,
a carry circuit,
an encoder circuit, and
a full adder circuit,
said input converter circuit for receiving one or more independent binary input signals, converting said binary signals into a first state signal having one unique bit and representative of the input binary signals,
each shift bar circuit having a plurality of state signal lines and a binary input signal connected to all of the state signal lines for shifting the state signals in accordance with the value of the shift bar input binary signal to create a modulo sum and carry bits in accordance with the combination of the independent input binary signals and the bar circuit input binary signals,
the state signal lines of one of the shift bar circuits coupled to the output of the input converter circuit for receiving the first state signal,
said restoration circuit coupled to the output of the last shift bar circuits for restoring the signal level of the state signals to their input levels,
said carry circuit coupled to the outputs of each shift bar circuit for generating an output corresponding to carry bits generated by the shift bar circuits,
said encoder circuit for converting the shift level modulo sum signal into a binary sum output signal,
said full adder circuit for adding one or more late-arriving binary signals to the binary sum output signal to produce a binary sum bit and a binary carry bit.

29. The partial product reduction matrix of claim 27 further comprising a final adder circuit.

30. The partial product reduction matrix of claim 27 wherein the first, second, and output numbers are integers expressed in binary form.

31. The partial product reduction matrix of claim 30 wherein the plurality of interconnected cascaded shift switch parallel counter circuits of the matrix reduction circuits comprises:
in a first stage, a plurality of shift switch parallel counters each compressing four inputs bits into two output bits and a plurality of shift switch parallel counters each compressing six inputs bits into two output bits, and
in a second stage, a plurality of shift switch parallel counters each compressing eight inputs bits into two output bits.

32. The partial product reduction matrix of claim 29 wherein the first, second, and output numbers are integers expressed in binary form, and Booth recoding is used to encode the first and second numbers for multiplication.

33. The partial product reduction matrix of claim 35 wherein the plurality of interconnected cascaded shift switch parallel counter circuits of the matrix reduction circuits comprises:
in a first stage, a plurality of shift switch parallel counters each compressing eight inputs bits into two output bits, and
in a second stage, a plurality of shift switch parallel counters each compressing nine inputs bits into two output bits.

34. The partial product reduction matrix 27 wherein the first, second, and output numbers are floating-point numbers expressed in binary form.

35. The partial product reduction matrix claim 34 wherein the plurality of interconnected cascaded shift switch parallel counter circuits of the matrix reduction circuits comprises:
in a first stage, a plurality of shift switch parallel counters each compressing seven inputs bits into two output bits and a plurality of shift switch parallel counters each compressing eight inputs bits into two output bits, and
in a second stage, a plurality of shift switch parallel counters each compressing four inputs bits into two output bits, and a plurality of shift switch parallel counters each compressing six inputs bits into two output bits.

36. The partial product reduction matrix 29 wherein the first, second, and output numbers are integers expressed in binary form.

37. The partial product reduction matrix 36 wherein the plurality of interconnected cascaded shift switch parallel counter circuits of the matrix reduction circuits comprises:
in a first stage, a plurality of shift switch parallel counters each compressing nine inputs bits into two output bits and a plurality of shift switch parallel counters each compressing two inputs bits into two output bits, and
in a second stage, a plurality of shift switch parallel counters each compressing four inputs bits into two output bits and a plurality of shift switch parallel counters each compressing six inputs bits into two output bits.

38. A small eight-by-eight shift switch parallel multiplier circuit for multiplying two eight-bit numbers, comprising a plurality of shift switch parallel counters, each shift switch parallel counter further comprising:
an input converter circuit,
two or more shift bar circuits cascaded with each other,
a restoration circuit,
a carry circuit,
an encoder circuit, and
a full adder circuit,
said input converter circuit for receiving one or more independent binary input signals, converting said binary signals into a first state signal having one unique bit and representative of the input binary signals,
each shift bar circuit having a plurality of state signal lines and a binary input signal connected to all of the state signal lines for shifting the state signals in accordance with the value of the shift bar input binary signal to create a modulo sum and carry bits in accordance with the combination of the independent input binary signals and the bar circuit input binary signals,
the state signal lines of one of the shift bar circuits coupled to the output of the input converter circuit for receiving the first state signal,
said restoration circuit coupled to the output of the last shift bar circuits for restoring the signal level of the state signals to their input levels,
said carry circuit coupled to the outputs of each shift bar circuit for generating an output corresponding to carry bits generated by the shift bar circuits,
said encoder circuit for converting the shift level modulo sum signal into a binary sum output signal,
said full adder circuit for adding one or more late-arriving binary signals to the binary sum output signal to produce a binary sum bit and a binary carry bit.

39. A small eight-by-eight shift switch parallel multiplier circuit for multiplying two eight-bit numbers, comprising:
a plurality of shift switch parallel counters compressing six inputs bits into two output bits,
a plurality of shift switch parallel counters compressing three inputs bits into two output bits,
a plurality of shift switch parallel counters compressing two inputs bits into two output bits,
a plurality of shift switch parallel counters compressing four inputs bits into three output bits.

40. The parallel multiplier of claim 39 comprising a composite sixteen-by-sixteen shift switch parallel multiplier circuit for multiplying two sixteen-bit numbers, comprising a plurality of the small eight-by-eight shift switch parallel multiplier circuits of claim 39.

41. The parallel multiplier of claim 40 comprising a composite thirty-two-by-thirty-two shift switch parallel multiplier circuit for multiplying two thirty-two-bit numbers, comprising a plurality of the composite sixteen-by-sixteen shift switch parallel multiplier circuits.

42. A composite sixty-four-by-sixty-four shift switch parallel multiplier circuit for multiplying two sixty-four-bit numbers, comprising a plurality of the composite thirty-two-by-thirty-two shift switch parallel multiplier circuits of claim 41.

43. A small shift switch parallel multiplier circuit for multiplying two binary numbers, comprising a plurality of shift switch parallel counters each further comprising a compressor circuit, each said compressor circuit further comprising:
two or more shift bar circuits cascaded with each other,
a restoration circuit,
a carry circuit, and
an encoder circuit,
each shift bar circuit having a plurality of state signal lines and a binary input signal connected to all of the state signal lines for shifting the state signals in accordance with the value of the shift bar input binary signal to create a modulo sum and carry bits in accordance with the combination of the independent input binary signals and the bar circuit input binary signals,
the state signal lines of one of the shift bar circuits coupled to the output of the input converter circuit for receiving the first state signal,
said restoration circuit coupled to the output of the last shift bar circuit for restoring the signal level of the state signals to their input levels,
said carry circuit coupled to the outputs of each shift bar circuit for generating an output corresponding to carry bits generated by the shift bar circuits,
said encoder circuit for converting the shift level modulo sum signal into a binary sum output signal.

44. A composite shift switch parallel multiplier circuit for multiplying two binary numbers, comprising a plurality of the small shift switch parallel multiplier circuits of claim 43.

45. A composite shift switch parallel multiplier circuit for multiplying two binary numbers, comprising a plurality of the composite shift switch parallel multiplier circuits of claim 44.

46. A reconfigurable matrix multiplier circuit for multiplying two mathematical matrices, comprising:
an input network of multipliers connected to input bit signal lines, for linking each input line to a plurality of configuration control switches,
a first output network of adders and a second output network of accumulators, said adder and accumulator networks connected to the configuration control switches
a plurality of configuration control switches connected to the reconfigurable input network and to the output networks for selecting among multiple input bit signal lines, and connecting the outputs of the multipliers to one of two output networks.

47. A composite reconfigurable matrix multiplier circuit, comprising a plurality of the reconfigurable matrix multiplier circuits of claim 46.

48. A composite reconfigurable matrix multiplier circuit, comprising a plurality of the composite reconfigurable matrix multiplier circuits of claim 47.

49. The configuration control circuit of claim 47, wherein the multipliers comprise:
a plurality of multiple shift switch parallel multiplier circuits for multiplying binary numbers, each shift switch parallel multiplier circuit further comprising a compressor circuit, each said compressor circuit further comprising:
two or more shift bar circuits cascaded with each other,
a restoration circuit,
a carry circuit, and
an encoder circuit,
each shift bar circuit having a plurality of state signal lines and a binary input signal connected to all of the state signal lines for shifting the state signals in accordance with the value of the shift bar input binary signal to create a modulo sum and carry bits in accordance with the combination of the independent input binary signals and the bar circuit input binary signals,
the state signal lines of one of the shift bar circuits coupled to the output of the input converter circuit for receiving the first state signal,
said restoration circuit coupled to the output of the last shift bar circuit for restoring the signal level of the state signals to their input levels,
said carry circuit coupled to the outputs of each shift bar circuit for generating an output corresponding to carry bits generated by the shift bar circuits,
said encoder circuit for converting the shift level modulo sum signal into a binary sum output signal.

50. The reconfigurable matrix multiplier circuit of claim 47, comprising a set of four smaller identical reconfigurable matrix multiplier circuits, each multiplying two 32-bit numbers or two 8-by-8 matrices.

51. The four matrix multiplier circuits of claim 50, each comprising a set of four identical matrix multiplier circuits, each multiplying two 16-bit numbers or two 4-by-4 matrices.

52. The four matrix multiplier circuits of claim 51, each comprising a set of four identical matrix multiplier circuits, each multiplying two 8-bit numbers or two 2-by-2 matrices.

53. The four matrix multiplier circuits of claim 53 each comprising a set of four identical matrix multiplier circuits, each multiplying two 4-bit numbers.

54. A pair of one-bit-controlled 64-bit switches enabling the matrix multiplier circuit of claim 50 to multiply either two 64-bit numbers or two 16-by-16 matrices.

55. A pair of one-bit-controlled 32-bit switches enabling the matrix multiplier circuit of claim 52 to multiply either two 32-bit numbers or two 8-by-8 matrices.

56. A pair of one-bit-controlled 16-bit switches enabling the matrix multiplier circuit of claim 52 to multiply either two 16-bit numbers or two 4-by-4 matrices.

57. A pair of one-bit-controlled 8-bit switches enabling the matrix multiplier circuit of claim 53 to multiply either two 8-bit numbers or two 2-by-2 matrices.
